(19) United States
(12) Patent Application Publication
(10) Pub. No.: US 2026/0014913 A1
(43) Pub. Date: Jan. 15, 2026

(54) CHILD RESTRAINT

(71) Applicant: Dorel Juvenile Group, Inc., Foxboro, MA (US)

(72) Inventors: Jonathan M. HOLTMAN, Brownsburg, IN (US); Jason H. JOHNSON, Brownstown, IN (US)

(21) Appl. No.: 19/266,929

(22) Filed: Jul. 11, 2025

Related U.S. Application Data
(60) Provisional application No. 63/670,215, filed on Jul. 12, 2024.
(60) Provisional application No. 63/829,064, filed on Jun. 24, 2025.

(51) Int. Cl. B60N 2/888; B60N 2/26; B60R 21/00; B60R 21/055

(52) U.S. Cl. CPC B60N 2/888; B60N 2/26; B60R 21/055; B60R 2021/0006; B60R 2021/0048

(57) ABSTRACT

A child restraint includes a seat bottom and a backrest coupled to the seat bottom and extending upwardly away from the seat bottom. The child restraint may include an integral headrest coupled to the backrest or a movable headrest coupled to the backrest and movable upwardly and downwardly along the backrest. The headrest includes a rear section, a first side section, and a second side section. The backrest includes a rear wall, a first side wing, and a second side wing. The headrest and the backrest are structured to manage side impacts.

### PRIORITY CLAIM

This application claims priority under 35 U.S.C. § 119(e) to U.S. Provisional Patent Application No. 63/670,215, filed Jul. 12, 2024 and U.S. Provisional Patent Application No. 63/829,064, filed Jun. 24, 2025, each of which is expressly incorporated by reference herein in its entirety.

### BACKGROUND

The present disclosure relates to a child safety device, and particularly to a child seat. More particularly, the present disclosure relates to a child seat for use in a vehicle.

### SUMMARY

According to the present disclosure, a child restraint includes a seat bottom and a backrest coupled to the seat bottom and extending upwardly away from the seat bottom. The child restraint may include an integral headrest coupled to the backrest or a movable headrest coupled to the backrest and movable upwardly and downwardly along the backrest.

In illustrative embodiments, the headrest includes a rear section, a first side section, and a second side section. Each of the first side section and the second side section includes a first energy-absorption surface and a second energy-absorption surface. The first and second energy-absorption surfaces cooperate to provide each of the first side section and the second side section with a generally convex shape relative to the child-receiving space in an unloaded state prior to a force acting on the first side section or the second side section. The first side section or the second side section are configured to change from the unloaded state to a loaded state in which the first and second energy-absorption surfaces of the first side section or the second side section cooperate to provide at least a portion of the first side section or the second side section with a concave shape relative to the child-receiving space in response to the force acting on the first side section or the second side section.

In illustrative embodiments, the child restraint further includes a side-impact management system. The side-impact management system may include a child-restraint harness coupled to the seat bottom and the seat back and configured to block movement of a child relative to the seat bottom and the seat back, a first side wing coupled to a first lateral end of the backrest, and a second side wing coupled to a second lateral end of the backrest.

In illustrative embodiments, each of the side wings are formed to include a shoulder-receiving, side-impact recess. The shoulder-receiving, side-impact recess is configured to receive the shoulder and/or arm region of the child during a side impact to cause the child-restraint harness to catch the child and to reduce a lateral force on the child from the side wings so that chest displacement of the child is minimized.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a child restraint including a seat shell at least partially defining a child-receiving space and a child-restraint harness configured to secure the child to the seat shell, the seat shell having a headrest having left and right side sections each with an outer surface facing toward the child-receiving space and configured to interact with the head of a child to reduce forces acting thereon during a side impact, and a hip-region support having an outer surface facing toward the child-receiving space and configured to interact with a hip region of the child to reduce forces acting thereon during the side impact;

FIG. 2 is a front perspective view of a portion of the child restraint and a child seated in the child-receiving space in a pre-impact state in which the child is located generally centrally in the child-receiving space and the child's head is spaced apart from the side sections of the headrest;

FIG. 3 is a front perspective view of the child restraint and the child in an impact state during a side impact where the child has moved toward one side of the child restraint, or one of the sides of the child restraint has moved toward the child, and showing the child's head contacting one of the side sections of the headrest to cause the side section of the headrest to move from an unloaded state, as shown in FIG. 2, in which at least a portion of the side section has a flat and/or convex shape relative to the child-receiving space, to a loaded state, as shown in FIG. 3, in which the side section is deformed by the child's head to a concave shape relative to the child-receiving to decelerate the child's head so that forces acting on the child's head are reduced or minimized;

FIG. 4 is a top view of the child restraint of FIG. 1 showing the headrest including a rear section, a first side section coupled to a first lateral side of the rear section and extending forward therefrom, and a second side section coupled to a second lateral side of the rear section and extending forward therefrom, and showing the outer surface of the first and second side sections each having a first energy-absorption surface having a first absolute slope relative to the rear section and a second energy-absorption surface having a second absolute slope relative to the rear section, the second absolute slope being less than the first absolute slope;

FIG. 5 is a perspective view of a second embodiment of child restraint including a seat shell at least partially defining a child-receiving space and a child-restraint harness configured to secure the child to the seat shell, the seat shell having a headrest having left and right side sections each with an outer surface facing toward the child-receiving space and configured to interact with the head of a child to reduce forces acting thereon during a side impact, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized;

FIG. 6 is a perspective view of a portion of the child restraint of FIG. 5 showing a child seated in the child-receiving space during a side impact event and showing the child's head contacting one of the side sections of the headrest to deform the side section from an unloaded state, in which the side section has a generally convex shape relative to the child-receiving space and a shoulder region of the child is located outside of the shoulder-receiving space, to a loaded state, in which the side section has a concave shape relative to the child receiving space and at least a portion of the shoulder region is located in the shoulder-receiving space;

FIG. 7 is a perspective view of a third embodiment of child restraint including a seat shell at least partially defining a child-receiving space and a child-restraint harness configured to secure the child to the seat shell, the seat shell having a headrest having left and right side sections each with an outer surface facing toward the child-receiving space and configured to interact with the head of a child to reduce forces acting thereon during a side impact, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized;

FIG. 8 is a perspective view of a portion of the child restraint of FIG. 7 showing a child seated in the child-receiving space during a side impact event and showing the child's head contacting one of the side sections of the headrest to deform the side section from an unloaded state, in which the side section has a generally convex shape relative to the child-receiving space and a shoulder region of the child is located outside of the shoulder-receiving space, to a loaded state, in which the side section has a concave shape relative to the child receiving space and at least a portion of the shoulder region is located in the shoulder-receiving space;

FIG. 9 is a cross section of the child restraint taken along line 9-9 in FIG. 7 showing the headrest including a rear section, a first side section coupled to a first lateral side of the rear section and extending forward therefrom, and a second side section coupled to a second lateral side of the rear section and extending forward therefrom, and showing the outer surface of the first and second side sections each having a first energy-absorption surface having a first absolute slope relative to the rear section and a second energy-absorption surface having a second absolute slope relative to the rear section, the second absolute slope being less than the first absolute slope, and showing a reinforcement rib connected to a rear surface of each side section to block deformation of each side section at a predetermined location along the outer surface;

FIG. 10 is a rear perspective view of the child restraint of FIG. 7 showing the reinforcement ribs coupled to the rear surface of the first and second side sections of the headrest;

FIG. 11 is a front plane view of a fourth embodiment of a child restraint including a seat shell and a child-restraint harness configured to secure the child to the seat shell, the seat shell having a headrest having an outer surface including a first energy-absorption surface and a second energy-absorption surface with a different absolute slope from one another, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing a scale where the child restraint is drawn to scale to show various dimensions of the recess and dimensional relationships of the recess to other features of the child restraint;

FIG. 12 is a cross section taken along line 12-12 in FIG. 11 showing the child restraint and scales where the child restraint is drawn to scale to show various dimensions of the recess and dimensional relationships of the recess to other features of the child restraint;

FIG. 13 is a cross section taken along the same plane as FIG. 12 but with a headrest of the child restraint removed to show the scales where the child restraint is drawn to scale to show various dimensions of the recess and dimensional relationships of the recess to other features of the child restraint;

FIG. 14 is a front plane view of a fifth embodiment of a child restraint including a seat shell and a child-restraint harness configured to secure the child to the seat shell, the seat shell having a headrest having an outer surface including a first energy-absorption surface and a second energy-absorption surface with a different absolute slope from one another, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing a scale where the child restraint is drawn to scale to show various dimensions of the recess and dimensional relationships of the recess to other features of the child restraint;

FIG. 15 is a cross section taken along line 15-15 in FIG. 14 showing the child restraint and scales where the child restraint is drawn to scale to show various dimensions of the recess and dimensional relationships of the recess to other features of the child restraint;

FIG. 16 is a cross section taken along the same plane as FIG. 15 but with a headrest of the child restraint removed to show the scales where the child restraint is drawn to scale to show various dimensions of the recess and dimensional relationships of the recess to other features of the child restraint;

FIG. 17 is a front plane view of a sixth embodiment of a child restraint including a seat shell and a child-restraint harness configured to secure the child to the seat shell, the seat shell having a headrest having an outer surface including a first energy-absorption surface and a second energy-absorption surface with a different absolute slope from one another, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing a scale where the child restraint is drawn to scale to show various dimensions of the recess and dimensional relationships of the recess to other features of the child restraint;

FIG. 18 is a cross section taken along line 18-18 in FIG. 17 showing the child restraint and scales where the child restraint is drawn to scale to show various dimensions of the recess and dimensional relationships of the recess to other features of the child restraint;

FIG. 19 is a cross section taken along the same plane as FIG. 18 but with a headrest of the child restraint removed to show the scales where the child restraint is drawn to scale to show various dimensions of the recess and dimensional relationships of the recess to other features of the child restraint;

FIG. 20 is a front plane view of a seventh embodiment of a child restraint including a seat shell and a child-restraint harness configured to secure the child to the seat shell, the seat shell having a headrest having an outer surface including a first energy-absorption surface and a second energy-absorption surface with a different absolute slope from one another, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing a scale where the child restraint is drawn to scale to show various dimensions of the recess and dimensional relationships of the recess to other features of the child restraint;

FIG. 21 is a cross section taken along line 21-21 in FIG. 20 showing the child restraint and scales where the child restraint is drawn to scale to show various dimensions of the recess and dimensional relationships of the recess to other features of the child restraint;

FIG. 22 is a front plane view of a eighth embodiment of a child restraint including a seat shell and a child-restraint harness configured to secure the child to the seat shell, the seat shell having a headrest having an outer surface including a first energy-absorption surface and a second energy-absorption surface with a different absolute slope from one another, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing a scale where the child restraint is drawn to scale to show various dimensions of the recess and dimensional relationships of the recess to other features of the child restraint;

FIG. 23 is a cross section taken along line 23-23 in FIG. 22 showing the child restraint and scales where the child restraint is drawn to scale to show various dimensions of the recess and dimensional relationships of the recess to other features of the child restraint;

FIG. 24 is a cross section taken along the same plane as FIG. 23 but with a headrest of the child restraint removed to show the scales where the child restraint is drawn to scale to show various dimensions of the recess and dimensional relationships of the recess to other features of the child restraint;

FIG. 25 is a front plane view of a nineth embodiment of a child restraint including a seat shell and a child-restraint harness configured to secure the child to the seat shell, the seat shell having a headrest having an outer surface including a first energy-absorption surface and a second energy-absorption surface with a different absolute slope from one another, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing a scale where the child restraint is drawn to scale to show various dimensions of the recess and dimensional relationships of the recess to other features of the child restraint;

FIG. 26 is a cross section taken along line 26-26 in FIG. 25 showing the child restraint and scales where the child restraint is drawn to scale to show various dimensions of the recess and dimensional relationships of the recess to other features of the child restraint;

FIG. 27 is a cross section taken along the same plane as FIG. 26 but with a headrest of the child restraint removed to show the scales where the child restraint is drawn to scale to show various dimensions of the recess and dimensional relationships of the recess to other features of the child restraint;

FIG. 28 is a front plane view of a tenth embodiment of a child restraint including a seat shell and a child-restraint harness configured to secure the child to the seat shell, the seat shell having a headrest having an outer surface including a first energy-absorption surface and a second energy-absorption surface with a different absolute slope from one another, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing a scale where the child restraint is drawn to scale to show various dimensions of the recess and dimensional relationships of the recess to other features of the child restraint;

FIG. 29 is a cross section taken along line 29-29 in FIG. 28 showing the child restraint and scales where the child restraint is drawn to scale to show various dimensions of the recess and dimensional relationships of the recess to other features of the child restraint; and

FIG. 30 is a cross section taken along the same plane as FIG. 29 but with a headrest of the child restraint removed to show the scales where the child restraint is drawn to scale to show various dimensions of the recess and dimensional relationships of the recess to other features of the child restraint.

### DETAILED DESCRIPTION

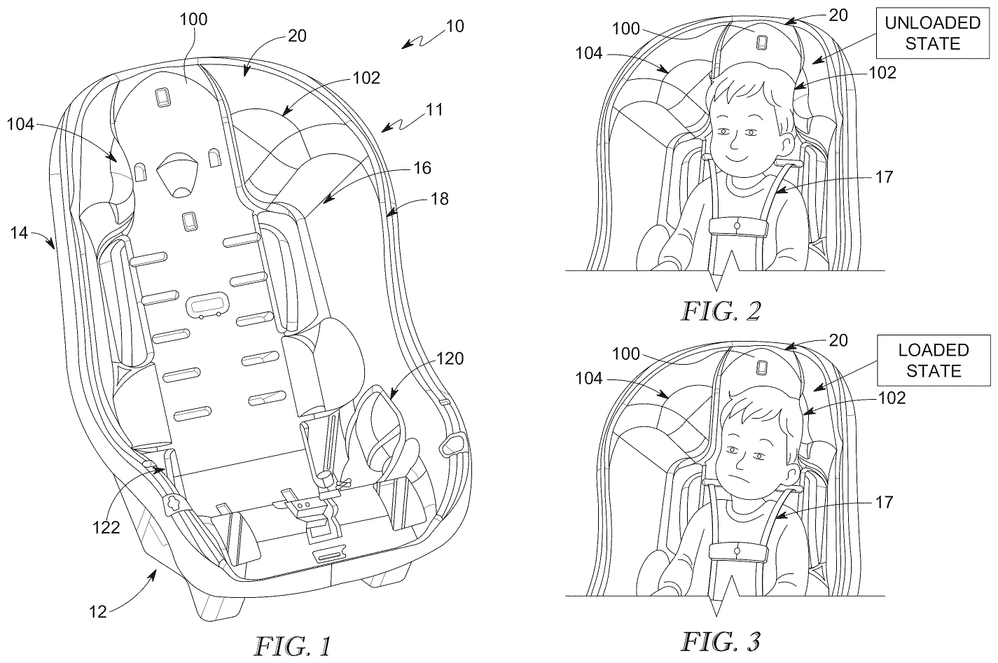

A child restraint 10, also called a juvenile seat, includes a seat shell 11 and a child-restraint harness 17 as shown in FIGS. 1-3. The seat shell 11 includes a seat bottom 12 and a seat back 14 coupled to the seat bottom 12 as shown in FIG. 1. The seat bottom 12 and the seat back 14 cooperate to define a child-receiving space 16 configured to receive a child for transportation in a vehicle. The seat back 14 and/or the child restraint harness 17 are configured to reduce forces experienced by the child during side impacts by improving upon head impact criterion and chest displacement as shown in FIGS. 2-4.

The seat back 14 includes a backrest 18 and a headrest 20 as shown in FIGS. 1 and 3-6. The backrest 18 is coupled to the seat bottom 12 and extends upwardly away from the seat bottom 12. The headrest 20 is coupled to the backrest 18 and may be movable upwardly and downwardly along the backrest 18 to accommodate different heights of the child as the child grows. The headrest 20 is sized and structured to support the head of the child while the backrest 18 is sized and structured to support the torso of the child separately from the headrest 20 during a side impact.

The headrest 20 is formed integrally with the backrest 18 and forms an upper end of the seat back 14 as shown in FIG. 1. The headrest 20 includes a rear section 100, a first side section 102, and a second side section 104. The rear section extends between and interconnects the first and second side section 102, 104 and is configured to support the back of a child's head seated on the child restraint 10. The first side section 102 extends outwardly away from the rear section 100 on a first lateral side of the head rest 20. The second side section 104 extends outwardly away from the rear section 100 on a second, opposite lateral side of the headrest 20 and is spaced apart from the first side section 102. In some embodiments, the headrest 20 can be separate from the backrest 18 and/or movable relative to the backrest 18 (e.g. slidable upward and downward along the backrest 18).

The first and second side sections 102, 104 of the headrest 20 are configured to reduce forces acting on the head of a child during side impacts, for example. Each side section 102, 104 includes an outer surface facing toward the head of a child. The outer surface of each side section 102, 104 varies in distance from one another to interact with the head of the child and reduce forces acting on the head of the child as the head contacts either outer surface. In some embodiments, the outer surface of each side section 102, 104 provides energy-redirection means to cause the head of the child to roll and/or turn as the head engages the side section 102, 104 during a side impact. Some examples of headrests that provide energy redirecting structure are shown and described in U.S. application Ser. No. 17/848,732, filed Jun. 24, 2022 and U.S. application Ser. No. 18/372,320, filed Sep. 25, 2023, the disclosure of each of which are hereby incorporated by reference herein in their entirety for the purpose of describing energy redirecting structures.

The outer surface of each side section 102, 104 includes a first energy-absorption surface 106 coupled to the rear section 100 and a second energy-absorption surface 108 coupled to a distal end of the first energy-absorption surface 106 and spaced apart from the rear section 100 as shown in FIGS. 1-4. A transition point 110 is located between the first and second energy-absorption surfaces 106, 108 in each side section 104, 106. The first energy-absorption surface 106 is arranged to lie along a first plane or curvature and the second energy-absorption surface 108 is arranged to lie along a second plane or curvature different than the first plane or curvature. The first energy-absorption surface 106 extends at a first angle or absolute slope (i.e. rise/run) relative to the rear section 100 and the second energy-absorption surface 108 extends at a second angle or absolute slope relative to the rear section 100. The second angle or absolute slope is less than the first angle or absolute slope. In some embodiments, the first and second energy-absorption surfaces provide each side section 104, 106 with a generally convex shape relative to the head of the child at least prior to a side impact. The term generally is used because one or both of the energy-absorption surfaces 106, 108 may be planar while still extending at different angles or slopes to one another, thereby forming the convex shape, collectively.

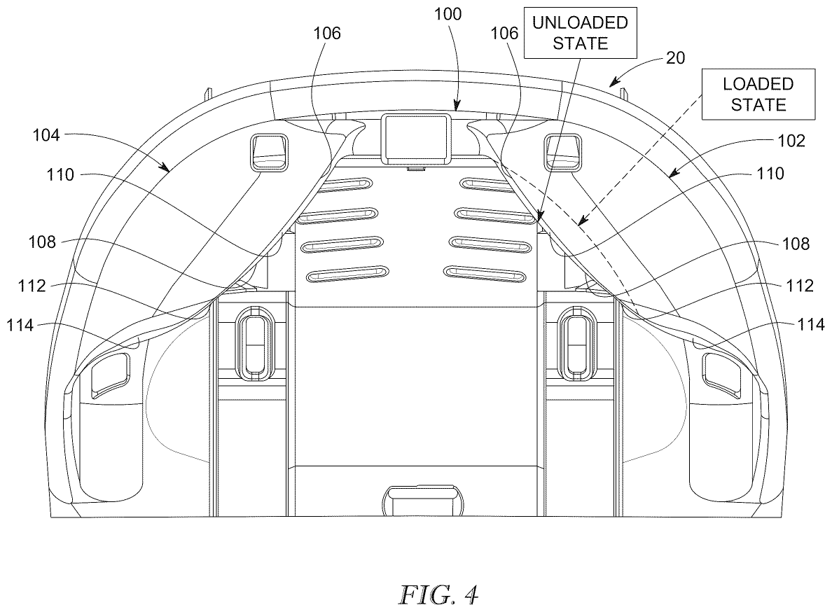

In the illustrative embodiment, at least one of side sections 102, 104 of the headrest 20 are configured to deform relative to the rear section 100 from an unloaded state to a loaded state as the head of the child contacts the side section 102 or 104 during a side impact as suggested in FIGS. 2 and 3. When each side section 102, 104 deforms, the generally convex shape of each respective side section 104, 106 may change to a generally concave shape relative to the head of the child as suggested in FIGS. 2 and 3. For example, the absolute angle or slope of the first energy-absorption surface may decrease as the side section 104, 106 deforms and/or the angle or slope of the second energy-absorption surface may increase as the side section 104, 106 deforms. The transition point 110 may move laterally outward away from the opposite side section 104, 106 and/or rearward closer to the rear section 100 as the side section 104, 106 deforms. In some embodiments, the first and second side sections 104, 106 of the headrest 20 further include a third energy-absorption surface 114 having a concave curvature relative to the child-receiving space and a second transition point 112 between the second energy-absorption surface 108 and the third energy-absorption surface 114 at a distal end of the second energy-absorption surface 108 as shown in FIG. 4.

The seat back 14 and/or seat bottom 12 may further include hip region supports 120, 122. Hip region supports 120, 122 each include a convexly-shaped surface relative to the child-receiving space 16. During a side impact, a child's hip may contact one of the hip region supports 120, 122 and deform the hip-region support to change the convexly-shaped surface to a concavely-shaped surface. This may reduce forces acting on the child during the side impact.

The backrest 18 and the headrest 20 may be formed from one or more polymeric materials and molded (i.e. injection molded, thermoformed, etc.) together. In other words, the backrest 18 and the headrest 20 may have a substantially constant thickness throughout. For example, the headrest 20 may have a substantially constant thickness (i.e. the thickness does not change by more than 5%) between an outer surface of the first and second side sections 102, 104 including the first and second energy-absorption surfaces 106, 108 and an inner surface facing away from the outer surface in both the unloaded state and the loaded state. Likewise, the hip region support 120 may have a substantially constant thickness throughout. Accordingly, the headrest 20 and the hip region support 120 are configured to only deform elastically under load and are not configured to compress. In other words, the headrest 20 and the hip region support 120 do not include a compressible foam or airbag. The headrest 20 and the hip region support 120 may be covered by a trim or soft goods material. The thicknesses described above are typically between 1/32 inch and 1/16 inch or between 1/16 inch and ⅛ inch but any suitable thickness can be used.

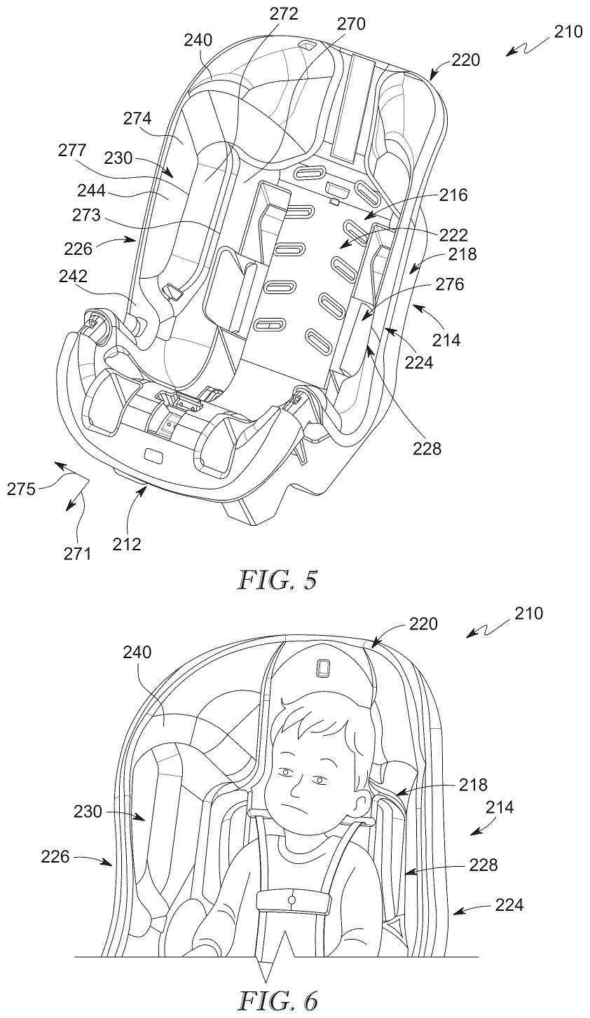

Another embodiment of a child restraint 210 is shown in FIGS. 5 and 6. Child restraint 210 is similar to child restraint 10 and the disclosure of child restraint 10 is hereby incorporated herein for child restraint 210 except for the differences discussed below.

The child restraint 210 includes a seat bottom 212 and a seat back 214 coupled to the seat bottom 212 as shown in FIG. 5. The seat bottom 212 and the seat back 214 cooperate to define a child-receiving space 216 configured to receive a child for transportation in a vehicle. The seat back 214 is configured to reduce forces experienced by the child during side impacts by improving upon chest displacement.

The seat back 214 includes a backrest 218 and a headrest 220 as shown in FIGS. 5 and 6. The backrest 218 is coupled to the seat bottom 212 and extends upwardly away from the seat bottom 212. The headrest 220 is coupled to the backrest 218 and may be movable upwardly and downwardly along the backrest 218 to accommodate different heights of the child as the child grows. The headrest 220 is sized and structured similarly to headrest 220 to support the head of the child while the backrest 218 is sized and structured to support the torso of the child separately from the headrest 220 during a side impact. The headrest 220 may deform similarly to headrest 20 during a side impact as suggested in FIG. 6.

The backrest 218 includes a rear wall 222 and left and right side wings 224, 226 coupled to respective lateral sides of the rear wall 222 as shown in FIG. 5. The rear wall 222 supports the headrest 220 relative to the rest of the child restraint 210. The left and right side wings 224, 226 extend forward away from the rear wall 222 so that the side wings 224, 226 at least partially surround the child's sides including their shoulder and/or arm regions.

Each of the side wings 224, 226 is formed to include a recess 228, 230 as shown in FIG. 5. The recesses 228, 230 provide space for the child's shoulder and/or arm regions to extend into during a side impact, thereby lessening forces experienced by the child. Each recess 228, 230 defines an empty space and a flexible soft-goods or trim material 260 overlies the side wings 224, 226 and the recesses 228, 230. The empty space may be filled with a flexible material such as a compressible foam having a rigidity less than the material forming the seat back 214. In some embodiments, the child's shoulder and/or arm regions extend into the recesses 228, 230 without contacting any rigid or force-reducing structures (e.g. foam, airbag, etc.). In some embodiments, the recesses 228, 230 are covered by a flexible material such as a fabric, bungee, straps, mesh, etc.

Each of the side wings 224, 226 includes an upper panel 240, a lower panel 242, and a medial panel 244 between the upper panel 240 and the lower panel 242 as shown in FIG. 5. The upper panel 240 is coupled to the headrest 220. The lower panel 242 supports the child's hips during side impacts. Panel 244 supports the shoulder during side impacts. The medial panel 244 is formed to include the recess 228, 230 such that at least a portion of the medial panel 244 is laterally further from the child than the upper panel 240 and the lower panel 242 to provide the spacing for the child's shoulder and/or arm regions during side impacts.

The medial panel 244 includes a rear segment 270 coupled to the rear wall 222 of the backrest 218, a laterally-extending segment 272 coupled to the rear segment 270, and an outwardly-extending segment 274 coupled to the laterally-extending segment 272 as shown in FIGS. 5 and 6. The rear segment 270 extends away from the rear wall 222 in at least a forward direction 271 of the child restraint 210. The laterally-extending segment 272 is coupled to a forwardmost end 273 of the rear segment 270 and extends away from the rear segment 270 in a lateral direction 275. The forward direction 271 is substantially perpendicular (i.e. between 85 degrees and 95 degrees) to the lateral direction 275. The outwardly-extending segment 274 is coupled to an outermost end 277 of the laterally-extending segment 272 and extends away from the backrest 270 in the forward direction 271. The recess 228, 230 is defined forward of the laterally-extending segment 272 and laterally adjacent to the outwardly-extending segment 274. The rear segment 270 may extend in the forward direction 271 and the lateral direction 275 (i.e. at an angle away from the rear wall 222).

The outwardly-extending segment 274 provides a medial side-impact barrier surface that extends along a majority of a height of the backrest 218 (i.e. greater than 50%). In some embodiments, the medial side-impact barrier surface has a height that is at least 50% of the height of the side wings 224, 226. In some embodiments, the medial side-impact barrier surface has a height that is at least 60% of the height of the side wings 224, 226. In some embodiments, the medial side-impact barrier surface has a height that is at least 70% of the height of the side wings 224, 226. In some embodiments, the medial side-impact barrier surface has a height that is at least 80% of the height of the side wings 224, 226. In some embodiments, the medial side-impact barrier surface has a height that is at least 90% of the height of the side wings 224, 226. Such heights ensure the recesses 28, 30 are sufficiently sized to accommodate the shoulder and arm region of the child across a wide range of child heights and ages.

In some embodiments, the rear segment 270 may be formed to include a pair of belt-path apertures 276 located rearward of the recesses 228, 230 as shown in FIG. 5. The belt-path apertures 276 may be formed entirely in the rear segment 270 of each side wing 224, 226 or partially in the rear segment 270 and partially in the rear wall 222. The belt path apertures 276 extend all the way through the seat shell 211 and are configured to receive an attachment belt, such as a seat belt included in the vehicle or a belt separate from the vehicle, to secure the child restraint 210 to the vehicle seat.

The recesses 228, 230 may provide means for allowing a shoulder region of a child seated in the child-receiving space to move into the recess during a side impact event so that impact forces experienced by the child during the side impact event are reduced. The recesses 228, 230 may provide means for satisfying federal safety standard FMVSS 213a. The recesses 228, 230 may provide means for unrestricting a shoulder region of a child seated in the child-receiving space as either of the side walls moves laterally toward the shoulder region of the child during a side impact event to cause the shoulder region of the child to move into the recess without contacting the seat back so that forces experienced by the child during the side impact event are transferred to a harness.

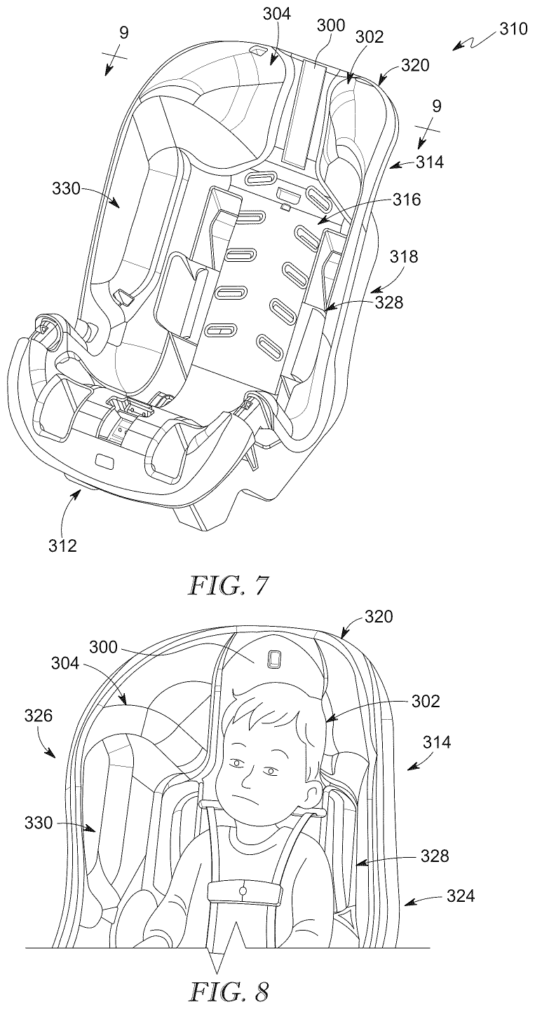

Another embodiment of a child restraint 310 is shown in FIGS. 7-10. Child restraint 310 includes features similar to child restraint 10 and child restraint 210 including a headrest 320 shaped similarly to headrest 20 and headrest 220 and side wings 322, 324 with recesses 328, 330 similar to recesses 228, 230. The disclosure of child restraints 10 and 210 are hereby incorporated herein for child restraint 310 except for the differences discussed below.

The child restraint 310 includes a seat bottom 312 and a seat back 314 coupled to the seat bottom 312 as shown in FIG. 7. The seat bottom 312 and the seat back 314 cooperate to define a child-receiving space 316 configured to receive a child for transportation in a vehicle. The seat back 314 is configured to reduce forces experienced by the child during side impacts by improving upon chest displacement.

The seat back 314 includes a backrest 318 and a headrest 320 as shown in FIGS. 7 and 8. The backrest 318 is coupled to the seat bottom 312 and extends upwardly away from the seat bottom 312. The headrest 320 is coupled to the backrest 318 and may be movable upwardly and downwardly along the backrest 318 to accommodate different heights of the child as the child grows. The headrest 320 is sized and structured similarly to headrest 20 to support the head of the child while the backrest 318 is sized and structured to support the torso of the child separately from the headrest 320 during a side impact. In some embodiments, the headrest 320 may deform similarly to headrest 20 during a side impact as suggested in FIG. 8.

The headrest 320 includes a rear section 300, a first side section 302, and a second side section 304. The rear section 300 extends between and interconnects the first and second side section 302, 304 and is configured to support the back of a child's head seated on the child restraint 310. The first side section 302 extends outwardly away from the rear section 300 on a first lateral side of the headrest 320. The second side section 304 extends outwardly away from the rear section 300 on a second, opposite lateral side of the headrest 320 and is spaced apart from the first side section 302. In some embodiments, the headrest 320 can be separate from the backrest 318 and/or movable relative to the backrest 318 (e.g. slidable upward and downward along the backrest 318).

The first and second side sections 302, 304 of the headrest 320 are configured to reduce forces acting on the head of a child during side impacts, for example. Each side section 302, 304 includes an outer surface facing toward the head of a child. The outer surface of each side section 302, 304 varies in distance from one another to interact with the head of the child and reduce forces acting on the head of the child as the head contacts either outer surface. In some embodiments, the outer surface of each side section 302, 304 provides energy-redirection means to cause the head of the child to roll and/or turn as the head engages the side section 302, 304 during a side impact.

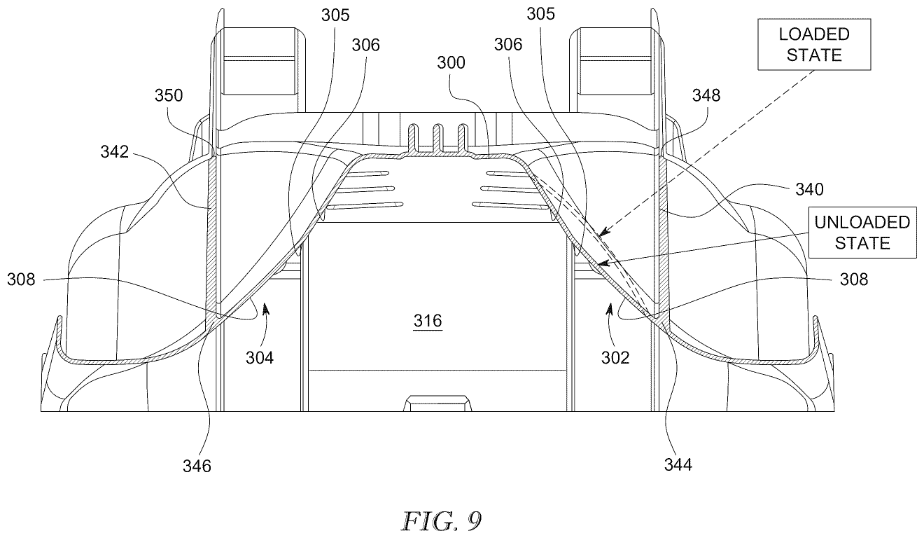

The outer surface of each side section 302, 304 includes a first energy-absorption surface 306 coupled to the rear section 300 and a second energy-absorption surface 308 coupled to a distal end of the first energy-absorption surface 306 and spaced apart from the rear section 300 as shown in FIG. 9. A transition point 305 is located between the first and second energy-absorption surfaces 306, 308 in each side section 302, 304. The first energy-absorption surface 306 is arranged to lie along a first plane or curvature and the second energy-absorption surface 308 is arranged to lie along a second plane or curvature different than the first plane or curvature. The first energy-absorption surface 306 extends at a first angle or slope relative to the rear section 300 and the second energy-absorption surface 308 extends at a second angle or slope relative to the rear section 300. The second angle or slope is less than the first angle or slope. In some embodiments, the first and second energy-absorption surfaces provide each side section 304, 306 with a generally convex shape relative to the head of the child at least prior to a side impact. The term generally is used because one or both of the energy-absorption surfaces 306, 308 may be planar while still extending at different angles or slopes to one another, thereby forming the convex shape, collectively.

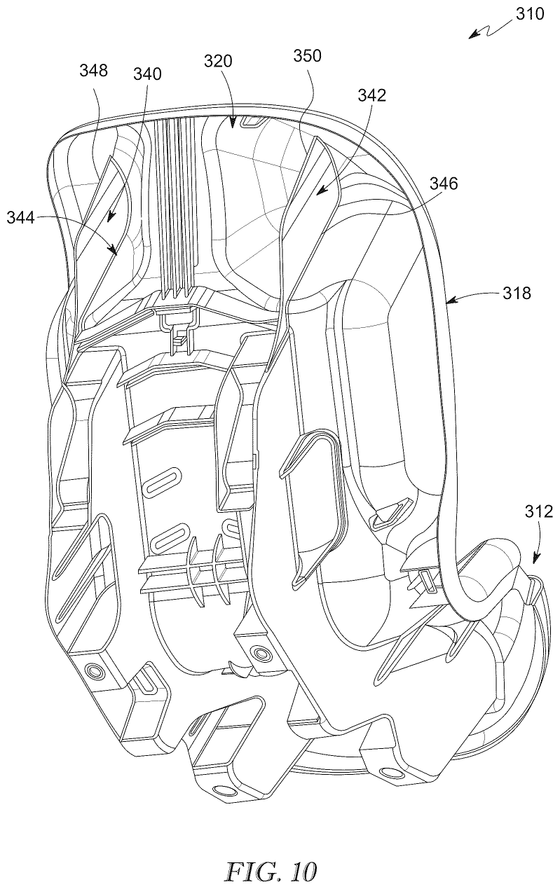

The headrest 320 further includes a pair of reinforcement ribs 340, 342 coupled to a backside of each respective side section 302, 304 as shown in FIGS. 9 and 10. A first reinforcement rib 340 is coupled to the first side section 302 and a second reinforcement rib 342 coupled to the second side section 304. Each reinforcement rib 340, 342 is configured to block at least partially, deformation of the headrest side sections 302, 304 relative to the rest of the child restraint 310.

Each reinforcement rib 340, 342 has a proximal end 344, 346 coupled to the backside of each respective side section 302, 304 and a distal end 348, 350 spaced apart from the respective side section 302, 304. Each proximal end 344, 346 is coupled to the back side of each respective side section 302, 304 between the transition point 305 and an end of the second energy-absorption surface 308 of each respective side section 302, 304. The reinforcement ribs 340, 342 are configured to block deformation of at least a portion of the second energy-absorption surfaces 308. Each side section 302, 304 may deform (i.e. change from convex to concave) between the proximal end 344, 346 of each respective reinforcement rib 340, 342 and the rear section 300 as a child's head contacts the side section 302, 304 during a side impact.

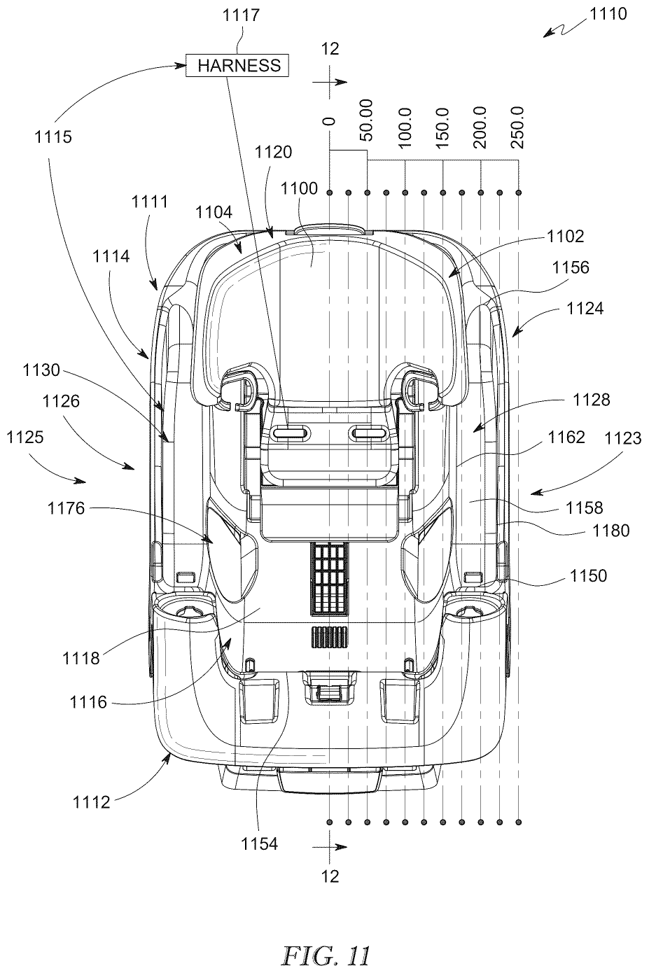

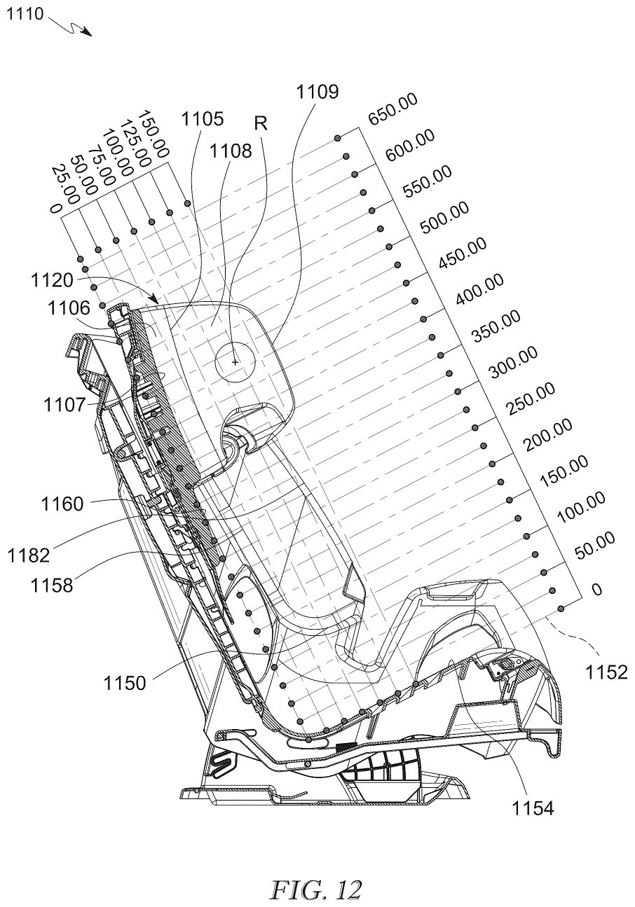

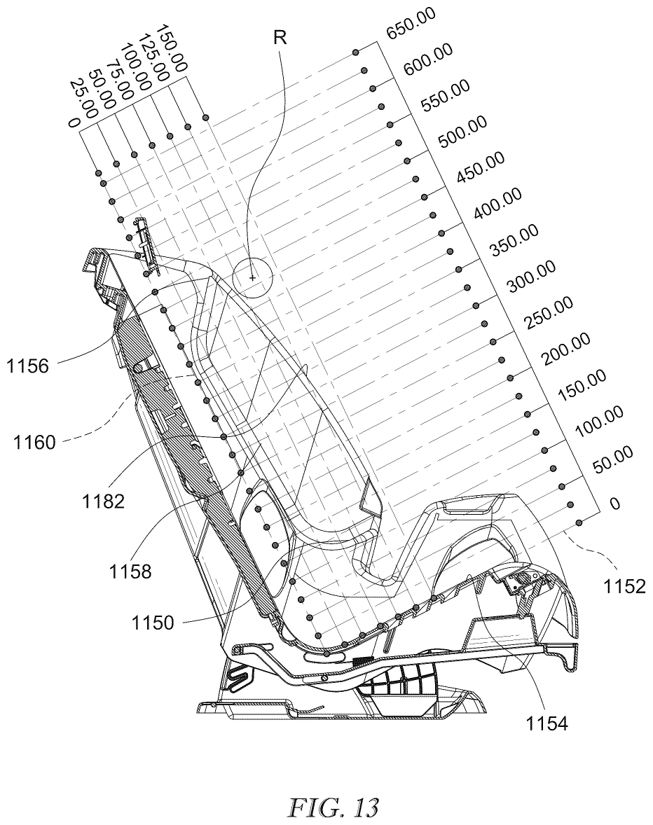

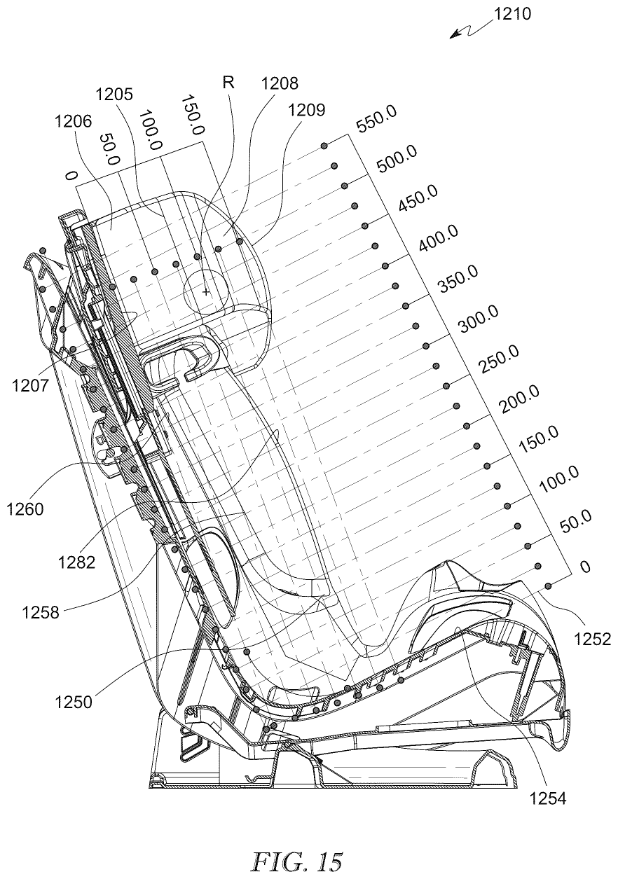

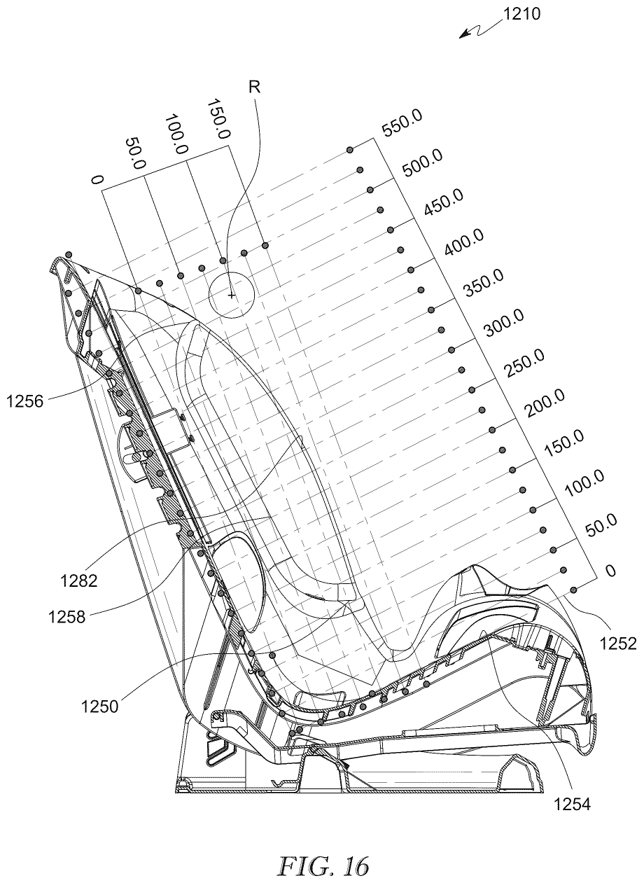

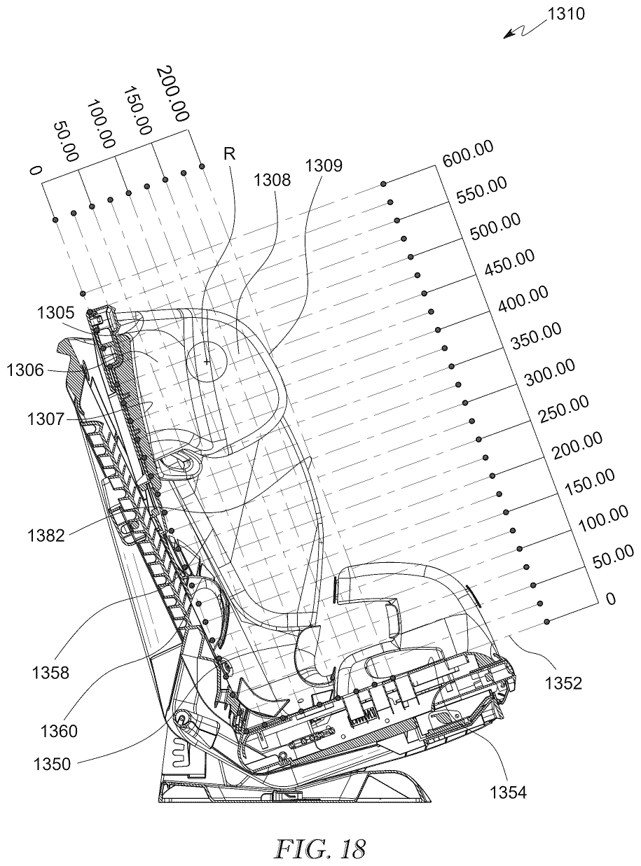

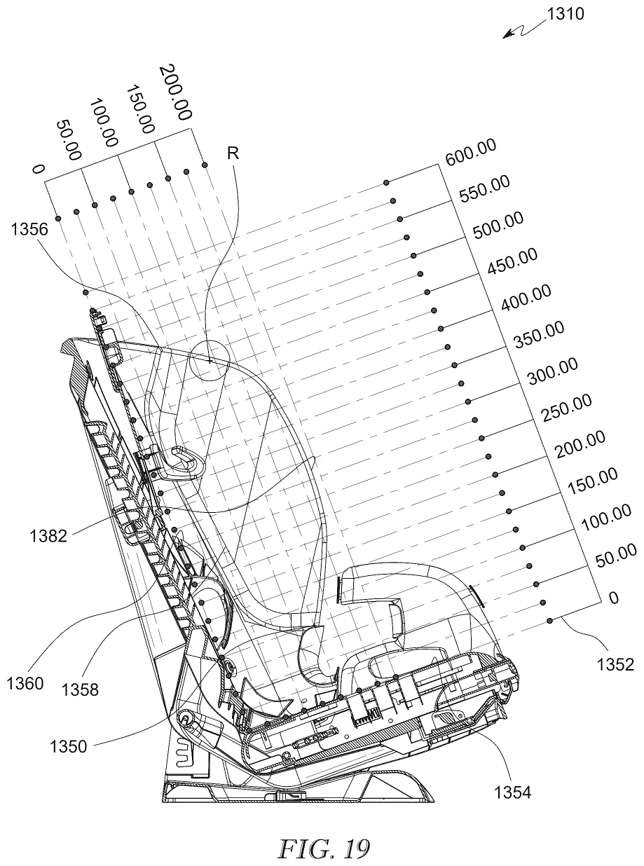

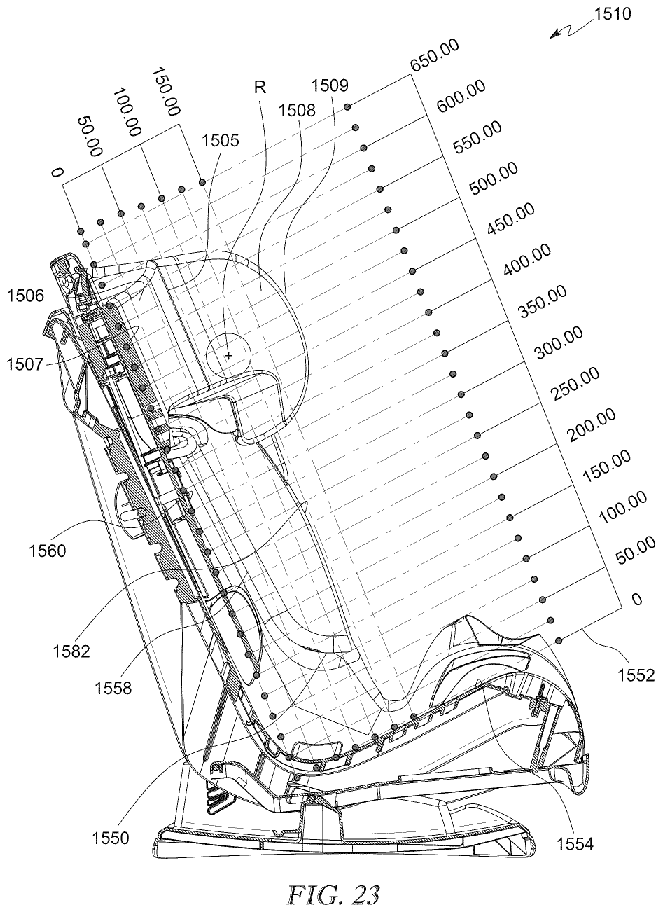

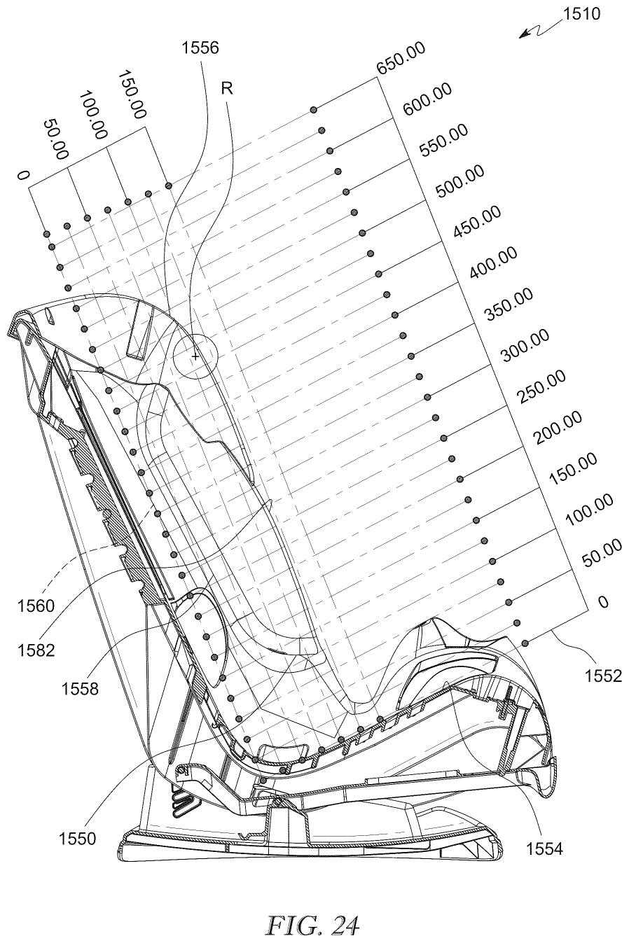

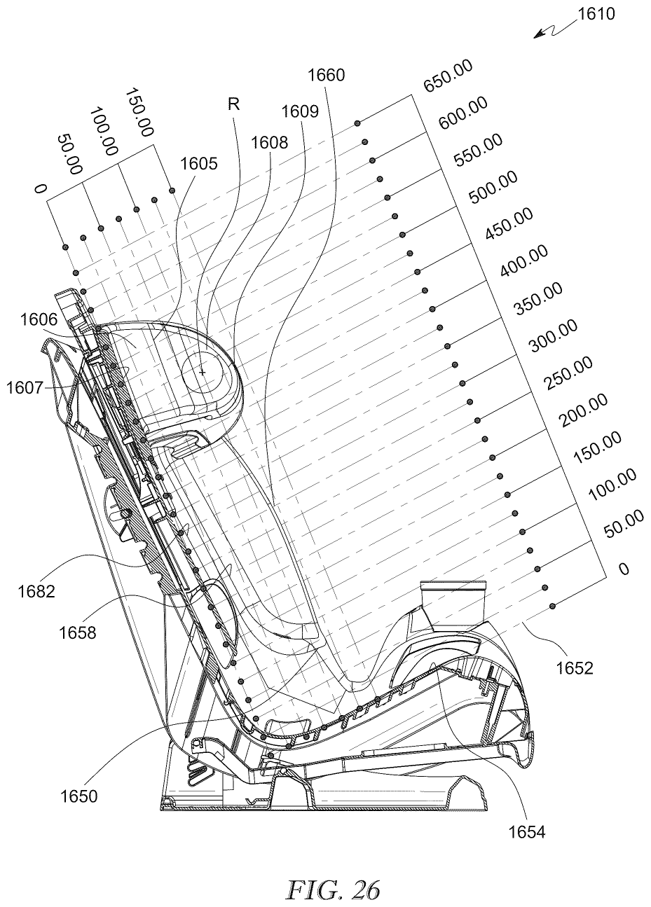

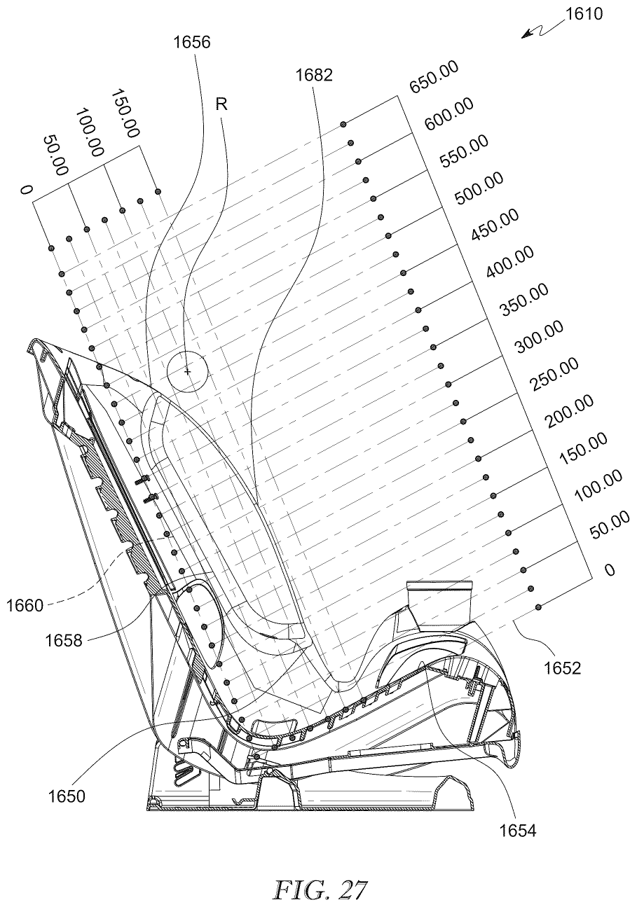

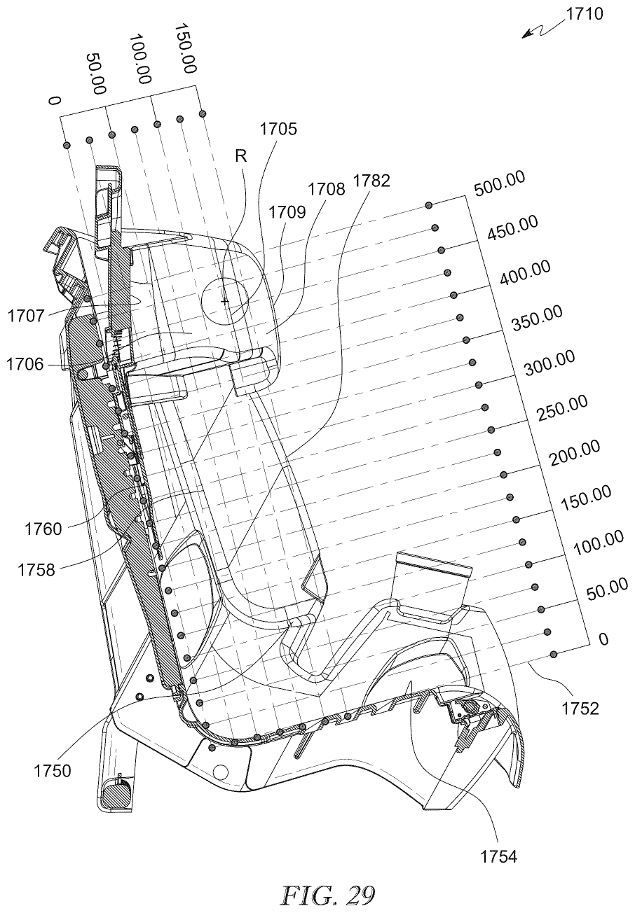

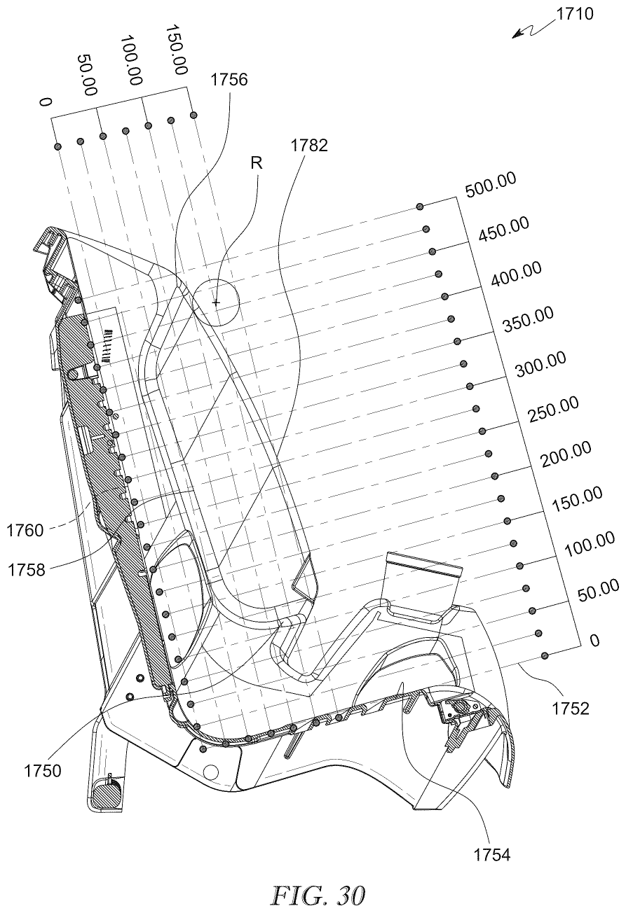

FIGS. 11-30 show additional examples of child restraints including side wings with recesses formed in the side wings to manage and mitigate chest displacement and a headrest configured to manage and mitigate head impact forces during an impact event. Each of FIGS. 11-30 is drawn to scale and scales are shown in each figure. All values shown in the scales are in millimeters (mm).

FIGS. 11-13 show a fourth embodiment of a child restraint 1110 including recesses 1128, 1130 in side wings 1124, 1126 of backrest 1118. Child restraint 1110 is similar to child restraint 10. Accordingly the disclosure of child restraint 10 is hereby incorporated herein for child restraint 1110.

Child restraint 1110 includes a seat shell 1111 and is formed to include a child-receiving space 1116 configured to hold a child for transportation in a vehicle. The seat shell 1111 includes a seat bottom 1112 and a seat back 1114 coupled to the seat bottom 1112. The seat back 1114 includes a backrest 1118 extending upwardly away from the seat bottom 1112 and a headrest 1120 coupled to the backrest 1118. The seat bottom 1112 and the seat back 1114 at least partially define the child-receiving space 1116. The headrest 1120 is movable upwardly and downwardly along the backrest 1118.

The headrest 1120 includes a rear section 1100, a first side section 1102, and a second side section 1104. The rear section 1100 extends between and interconnects the first and second side section 1102, 1104 and is configured to support the back of a child's head seated on the child restraint 1110. The first side section 1102 extends outwardly away from the rear section 1100 on a first lateral side of the headrest 1120. The second side section 1104 extends outwardly away from the rear section 1100 on a second, opposite lateral side of the headrest 1120 and is spaced apart from the first side section 1102. In some embodiments, the headrest 1120 can be integrally formed with the backrest 1118 and coupled to an upper end of the backrest 1118.

The first and second side sections 1102, 1104 of the headrest 1120 are configured to reduce forces acting on the head of a child during side impacts, for example. Each side section 1102, 1104 includes an outer surface facing toward the head of a child. The outer surface of each side section 1102, 1104 varies in distance from one another to interact with the head of the child and reduce forces acting on the head of the child as the head contacts either outer surface. In some embodiments, the outer surface of each side section 1102, 1104 provides energy-redirection means to cause the head of the child to roll and/or turn as the head engages the side section 1102, 1104 during a side impact.

The outer surface of each side section 1102, 1104 includes a first energy-absorption surface 1106 coupled to the rear section 1100 and a second energy-absorption surface 1108 coupled to a distal end of the first energy-absorption surface 1106 and spaced apart from the rear section 1100. A transition point 1105 is located between the first and second energy-absorption surfaces 1106, 1108 in each side section 1102, 1104. The transition point 1105 is spaced apart from a centerline of the headrest 1120 between the first and second side sections 1102, 1104 by a width distance within a range of 50 mm and 100 mm. In some embodiments, the width distance is within a range of 50 mm to 75 mm. In some embodiments, the width distance is about 65 mm. In some embodiments, the width distance is no more than 100 mm and/or no less than 50 mm.

The transition point 1105 is also spaced apart from a seating surface 1107 provided by the rear section 1100 of the headrest 1120 by a depth distance of 15 mm to 50 mm. In some embodiments, the depth distance is within a range of 25 mm to 35 mm. In some embodiments, the depth distance is about 30 mm.

The transition point 1105 is also spaced apart from a reference point R by a distance of 50 mm to 75 mm. In some embodiments, the distance is within a range of 55 mm to 65 mm. In some embodiments, the distance is about 60 mm. In the illustrative embodiment, the reference point R is located in front of the transition point 1105. Positioning the transition point 1105 rearward of the reference point R aligns the reference point R with the second energy-absorption surface and causes a region of the head rearward of the transition point 1105 to contact the first energy-absorption surface 1106 first during the side impact so that the first and second energy-absorption surfaces cooperate to induce head roll along the side section and disperse forces.

The first energy-absorption surface 1106 and the second energy-absorption surface 1108 have a depth ratio (i.e. depth distance from surface 1107 to transition point 1105 divided by depth distance from transition point 1105 to distal end 1109 of surface 1108) within a range of 0.2 to 1. In some embodiments, the depth ratio is within a range of 0.2 to 0.8. In some embodiments, the depth ratio is within a range of 0.2 to 0.6. In some embodiments, the depth ratio is within a range of 0.2 to 0.4. In some embodiments, the depth ratio is about 0.25. These distances and ratio provide the headrest 1120 with energy-redirection means to cause the head of the child to contact the first energy-absorption surface 1106 first during a side impact and then maintain contact with one of the side sections 1102, 1104 during the side impact to cause the head of the child to roll along the first energy-absorption surface 1106 and then the second energy-absorption surface 1108 to disperse forces on the child's head over a larger distance and/or surface area thereby reducing the cumulative force experienced by the child's head.

In illustrative embodiments, the child restraint 1110 further includes a side-impact management system 1115 coupled to at least one of the seat bottom 1112 and the seat back 1114. The side-impact management system 1115 is configured to provide means for managing chest displacement of the child during a side impact to reduce a lateral force on a shoulder region of the child during the side impact so that chest displacement of the child is minimized.

The side-impact management system 1115 includes a child-restraint harness 1117 coupled to the seat shell 1111, a first side wing 1124 coupled to a first lateral side 1123 of the backrest 1118 and projecting forward therefrom, and a second side wing 1126 coupled to a second lateral side 1125 of the backrest and projecting forward therefrom. The child-restraint harness 1117 is configured to restrain the child in the child-receiving space 1116. Each side wing 1124, 1126 is formed to include a shoulder-receiving side-impact recess 1128, 1130. The shoulder-receiving side-impact recess 1128, 1130 of the first side wing 1124 or the second side wing 1126 is configured to receive the shoulder and/or arm region of the child during the side impact event.

A lowermost end 1150 of the recess 1128, 1130 is located within 125 mm of a seat bottom plane 1152 established by a seating surface 1154 of the seat bottom 1112. In some embodiments, the lowermost end 1150 of the recess 1128, 1130 is located within 115 mm of the seat bottom plane 1152. In some embodiments, the lowermost end 1150 of the recess 1128, 1130 is located within 110 mm of the seat bottom plane 1152. In some embodiments, the lowermost end 1150 of the recess 1128, 1130 is located about (i.e. within 10 mm) 100 mm of the seat bottom plane 1152. Such spacing provides sufficient distance to receive the arm region of the child while providing a lower panel to engage the hip region of the child.

An uppermost end 1156 of the recess 1128, 1130 is located at least 400 mm from the seat bottom plane 1152. In some embodiments, the uppermost end 1156 is located at least 425 mm from the seat bottom plane 1152. In some embodiments, the uppermost end 1156 is located at least 450 mm from the seat bottom plane 1152. In some embodiments, the uppermost end 1156 is located at least 475 mm from the seat bottom plane 1152. In some embodiments, the uppermost end 1156 is located about (i.e. within 10 mm) 480 mm from the seat bottom plane 1152. Such spacing provides sufficient distance to receive the shoulder and/or arm region of the child while providing an upper panel to support the head region of the child across a wide range of heights of the child.

The uppermost end 1156 of the recess 1128, 1130 is located within 50 mm of a reference point R located about (i.e. within 10 mm) 460 mm from the seat bottom plane 1152. The reference point R represents a center of gravity of a head of a 3 year old test dummy sized according to Subpart W from 49 CFR part 572 at the time of filing this application.

Each side wing 1124, 1126 is formed to include a belt path opening 1176 located between the backrest 1118 and the recess 1128, 1130. An innermost end 1158 of the recess 1128, 1130 is spaced a distance from a seating surface 1160 provided by the seat back 1114 within a range of about 25 mm to about 75 mm. Each recess 1128, 1130 has a width from an innermost end 1162 to a medial side-impact barrier surface 1180 of at least 50 mm. In some embodiments, the recess 1128, 1130 has a width of at least 75 mm. In some embodiments, the recess 1128, 1130 has a width of about (i.e. within 10 mm) 60 mm. Such dimensions provide sufficient spacing for the shoulder and/or arm region of the child to move laterally during a side impact event to minimize chest displacement.

Each recess 1128, 1130 has a depth from the rearmost end 1158 to a forwardmost end 1182 of at least 75 mm. In some embodiments, the recess 1128, 1130 has a depth of at least 100 mm. In some embodiments, the recess 1128, 1130 has a depth of about (i.e. within 10 mm) 110 mm. Such dimensions provide sufficient forward projection of the side wings 1124, 1126 to restrain the shoulder and/or arm region of the child.

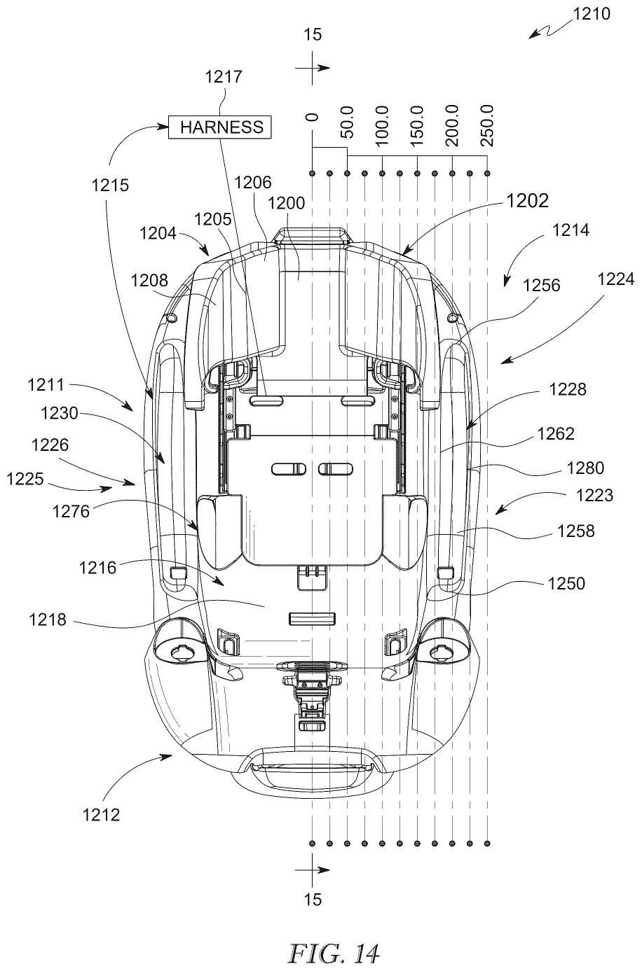

FIGS. 14-16 show a fifth embodiment of a child restraint 1210 including recesses 1228, 1230 in side wings 1224, 1226 of backrest 1218. Child restraint 1210 is similar to child restraint 10. Accordingly the disclosure of child restraint 10 is hereby incorporated herein for child restraint 1210.

Child restraint 1210 includes a seat shell 1211 and is formed to include a child-receiving space 1216 configured to hold a child for transportation in a vehicle. The seat shell 1211 includes a seat bottom 1212 and a seat back 1214 coupled to the seat bottom 1212. The seat back 1214 includes a backrest 1218 extending upwardly away from the seat bottom 1212 and a headrest 1220 coupled to the backrest 1218. The seat bottom 1212 and the seat back 1214 at least partially define the child-receiving space 1216.

The headrest 1220 includes a rear section 1200, a first side section 1202, and a second side section 1204. The rear section 1200 extends between and interconnects the first and second side section 1202, 1204 and is configured to support the back of a child's head seated on the child restraint 1210. The first side section 1202 extends outwardly away from the rear section 1200 on a first lateral side of the headrest 1220. The second side section 1204 extends outwardly away from the rear section 1200 on a second, opposite lateral side of the headrest 1220 and is spaced apart from the first side section 1202. In some embodiments, the headrest 1220 can be integrally formed with the backrest 1218 and coupled to an upper end of the backrest 1218.

The first and second side sections 1202, 1204 of the headrest 1220 are configured to reduce forces acting on the head of a child during side impacts, for example. Each side section 1202, 1204 includes an outer surface facing toward the head of a child. The outer surface of each side section 1202, 1204 varies in distance from one another to interact with the head of the child and reduce forces acting on the head of the child as the head contacts either outer surface. In some embodiments, the outer surface of each side section 1202, 1204 provides energy-redirection means to cause the head of the child to roll and/or turn as the head engages the side section 1202, 1204 during a side impact.

The outer surface of each side section 1202, 1204 includes a first energy-absorption surface 1206 coupled to the rear section 1200 and a second energy-absorption surface 1208 coupled to a distal end of the first energy-absorption surface 1206 and spaced apart from the rear section 1200. A transition point 1205 is located between the first and second energy-absorption surfaces 1206, 1208 in each side section 1202, 1204. The transition point 1205 is spaced apart from a centerline of the headrest 1220 between the first and second side sections 1202, 1204 by a width distance within a range of 75 mm and 125 mm. In some embodiments, the width distance is within a range of 85 mm to 110 mm. In some embodiments, the width distance is about 95 mm. In some embodiments, the width distance is no more than 100 mm and/or no less than 75 mm.

The transition point 1205 is also spaced apart from a seating surface 1207 provided by the rear section 1200 of the headrest 1220 by a depth distance of 60 mm to 90 mm. In some embodiments, the depth distance is within a range of 70 mm to 85 mm. In some embodiments, the depth distance is about 80 mm.

The transition point 1205 is also spaced apart from a reference point R by a distance of 5 mm to 25 mm. In some embodiments, the distance is within a range of 10 mm to 20 mm. In some embodiments, the distance is about 15 mm. In the illustrative embodiment, the reference point R is located in front of the transition point 1205. Positioning the transition point 1205 rearward of the reference point R aligns the reference point R with the second energy-absorption surface and causes a region of the head rearward of the transition point 1205 to contact the first energy-absorption surface 1206 first during the side impact so that the first and second energy-absorption surfaces cooperate to induce head roll along the side section and disperse forces.

The first energy-absorption surface 1206 and the second energy-absorption surface 1208 have a depth ratio (i.e. depth distance from surface 1207 to transition point 1205 divided by depth distance from transition point 1205 to distal end 1209 of surface 1208) within a range of 0.7 to 1.3. In some embodiments, the depth ratio is within a range of 0.8 to 1.1. In some embodiments, the depth ratio is within a range of 0.9 to 1.1. In some embodiments, the depth ratio is about 1. These distances and ratio provide the headrest 1220 with energy-redirection means to cause the head of the child to contact the first energy-absorption surface 1206 first during a side impact and then maintain contact with one of the side sections 1202, 1204 during the side impact to cause the head of the child to roll along the first energy-absorption surface 1206 and then the second energy-absorption surface 1208 to disperse forces on the child's head over a larger distance and/or surface area thereby reducing the cumulative force experienced by the child's head.

In illustrative embodiments, the child restraint 1210 further includes a side-impact management system 1215 coupled to at least one of the seat bottom 1212 and the seat back 1214. The side-impact management system 1215 is configured to provide means for managing chest displacement of the child during a side impact to reduce a lateral force on a shoulder region of the child during the side impact so that chest displacement of the child is minimized.

The side-impact management system 1215 includes a child-restraint harness 1217 coupled to the seat shell 1211, a first side wing 1224 coupled to a first lateral side 1223 of the backrest 1218 and projecting forward therefrom, and a second side wing 1226 coupled to a second lateral side 1225 of the backrest and projecting forward therefrom. The child-restraint harness 1217 is configured to restrain the child in the child-receiving space 1216. Each side wing 1224, 1226 is formed to include a shoulder-receiving side-impact recess 1228, 1230. The shoulder-receiving side-impact recess 1228, 1230 of the first side wing 1224 or the second side wing 1226 is configured to receive the shoulder and/or arm region of the child during the side impact event.

A lowermost end 1250 of the recess 1228, 1230 is located within 125 mm of a seat bottom plane 1252 established by a seating surface 1254 of the seat bottom 1212. In some embodiments, the lowermost end 1250 of the recess 1228, 1230 is located within 115 mm of the seat bottom plane 1252. In some embodiments, the lowermost end 1250 of the recess 1228, 1230 is located within 110 mm of the seat bottom plane 1252. In some embodiments, the lowermost end 1250 of the recess 1228, 1230 is located about (i.e. within 10 mm) 100 mm of the seat bottom plane 1252. Such spacing provides sufficient distance to receive the arm region of the child while providing a lower panel to engage the hip region of the child.

An uppermost end 1256 of the recess 1228, 1230 is located at least 400 mm from the seat bottom plane 1252. In some embodiments, the uppermost end 1256 is located at least 425 mm from the seat bottom plane 1252. In some embodiments, the uppermost end 1256 is located at least 450 mm from the seat bottom plane 1252. In some embodiments, the uppermost end 1256 is located at least 475 mm from the seat bottom plane 1252. In some embodiments, the uppermost end 1256 is located about (i.e. within 10 mm) 460 mm from the seat bottom plane 1252. Such spacing provides sufficient distance to receive the shoulder and/or arm region of the child while providing an upper panel to support the head region of the child across a wide range of heights of the child.

The uppermost end 1256 of the recess 1228, 1230 is located within 50 mm of a reference point R located about (i.e. within 10 mm) 460 mm from the seat bottom plane 1252. The reference point R represents a center of gravity of a head of a 3 year old test dummy sized according to Subpart W from 49 CFR part 572 at the time of filing this application.

Each side wing 1224, 1226 is formed to include a belt path opening 1276 located between the backrest 1118 and the recess 1228, 1230. A rearmost end 1258 of the recess 1228, 1230 is spaced a distance from a seating surface 1260 provided by the seat back 1214 within a range of about 25 mm to about 75 mm. Each recess 1228, 1230 has a width from an innermost end 1262 to a medial side-impact barrier surface 1280 of at least 50 mm. In some embodiments, the recess 1228, 1230 has a width of at least 75 mm. In some embodiments, the recess 1228, 1230 has a width of about (i.e. within 10 mm) 50 mm. Such dimensions provide sufficient spacing for the shoulder and/or arm region of the child to move laterally during a side impact event to minimize chest displacement.

Each recess 1228, 1230 has a depth from the rearmost end 1258 to a forwardmost end 1282 of at least 75 mm. In some embodiments, the recess 1228, 1230 has a depth of at least 100 mm. In some embodiments, the recess 1228, 1230 has a depth of about (i.e. within 10 mm) 75 mm. Such dimensions provide sufficient forward projection of the side wings 1224, 1226 to restrain the shoulder and/or arm region of the child.

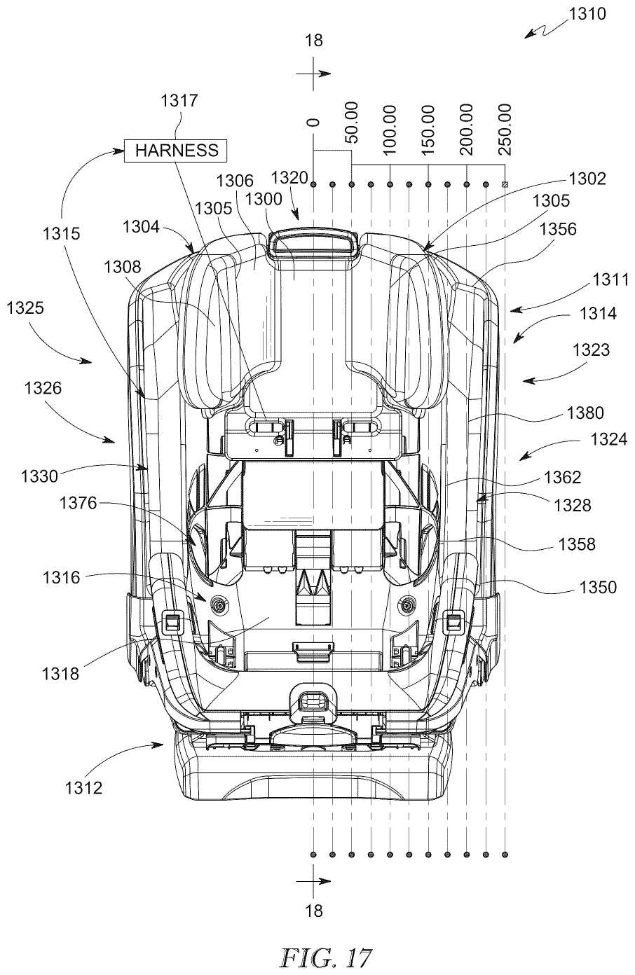

FIGS. 17-19 show a sixth embodiment of a child restraint 1310 including recesses 1328, 1330 in side wings 1324, 1326 of backrest 1318. Child restraint 1310 is similar to child restraint 10. Accordingly the disclosure of child restraint 10 is hereby incorporated herein for child restraint 1310.

Child restraint 1310 includes a seat shell 1311 and is formed to include a child-receiving space 1316 configured to hold a child for transportation in a vehicle. The seat shell 1311 includes a seat bottom 1312 and a seat back 1314 coupled to the seat bottom 1312. The seat back 1314 includes a backrest 1318 extending upwardly away from the seat bottom 1312 and a headrest 1320 coupled to the backrest 1318. The seat bottom 1312 and the seat back 1314 at least partially define the child-receiving space 1316.

The headrest 1320 includes a rear section 1300, a first side section 1302, and a second side section 1304. The rear section 1300 extends between and interconnects the first and second side section 1302, 1304 and is configured to support the back of a child's head seated on the child restraint 1310. The first side section 1302 extends outwardly away from the rear section 1300 on a first lateral side of the headrest 1320. The second side section 1304 extends outwardly away from the rear section 1300 on a second, opposite lateral side of the headrest 1320 and is spaced apart from the first side section 1302. In some embodiments, the headrest 1320 can be integrally formed with the backrest 1318 and coupled to an upper end of the backrest 1318.

The first and second side sections 1302, 1304 of the headrest 1320 are configured to reduce forces acting on the head of a child during side impacts, for example. Each side section 1302, 1304 includes an outer surface facing toward the head of a child. The outer surface of each side section 1302, 1304 varies in distance from one another to interact with the head of the child and reduce forces acting on the head of the child as the head contacts either outer surface. In some embodiments, the outer surface of each side section 1302, 1304 provides energy-redirection means to cause the head of the child to roll and/or turn as the head engages the side section 1302, 1304 during a side impact.

The outer surface of each side section 1302, 1304 includes a first energy-absorption surface 1306 coupled to the rear section 1300 and a second energy-absorption surface 1308 coupled to a distal end of the first energy-absorption surface 1306 and spaced apart from the rear section 1300. A transition point 1305 is located between the first and second energy-absorption surfaces 1306, 1308 in each side section 1302, 1304. The transition point 1305 is spaced apart from a centerline of the headrest 1320 between the first and second side sections 1302, 1304 by a width distance within a range of 75 mm and 125 mm. In some embodiments, the width distance is within a range of 85 mm to 110 mm. In some embodiments, the width distance is about 95 mm. In some embodiments, the width distance is no more than 105 mm and/or no less than 80 mm.

The transition point 1305 is also spaced apart from a seating surface 1307 provided by the rear section 1300 of the headrest 1320 by a depth distance of 60 mm to 100 mm. In some embodiments, the depth distance is within a range of 70 mm to 85 mm. In some embodiments, the depth distance is about 80 mm.

The transition point 1305 is also spaced apart from a reference point R by a distance of 10 mm to 30 mm. In some embodiments, the distance is within a range of 15 mm to 25 mm. In some embodiments, the distance is about 20 mm. In the illustrative embodiment, the reference point R is located in front of the transition point 1305. Positioning the transition point 1305 rearward of the reference point R aligns the reference point R with the second energy-absorption surface and causes a region of the head rearward of the transition point 1305 to contact the first energy-absorption surface 1306 first during the side impact so that the first and second energy-absorption surfaces cooperate to induce head roll along the side section and disperse forces.

The first energy-absorption surface 1306 and the second energy-absorption surface 1308 have a depth ratio (i.e. depth distance from surface 1307 to transition point 1305 divided by depth distance from transition point 1305 to distal end 1309 of surface 1308) within a range of 0.7 to 1.3. In some embodiments, the depth ratio is within a range of 0.8 to 1.1. In some embodiments, the depth ratio is within a range of 0.9 to 1.2. In some embodiments, the depth ratio is about 1.1. These distances and ratio provide the headrest 1320 with energy-redirection means to cause the head of the child to contact the first energy-absorption surface 1306 first during a side impact and then maintain contact with one of the side sections 1302, 1304 during the side impact to cause the head of the child to roll along the first energy-absorption surface 1306 and then the second energy-absorption surface 1308 to disperse forces on the child's head over a larger distance and/or surface area thereby reducing the cumulative force experienced by the child's head.

In illustrative embodiments, the child restraint 1310 further includes a side-impact management system 1315 coupled to at least one of the seat bottom 1312 and the seat back 1314. The side-impact management system 1315 is configured to provide means for managing chest displacement of the child during a side impact to reduce a lateral force on a shoulder region of the child during the side impact so that chest displacement of the child is minimized.

The side-impact management system 1315 includes a child-restraint harness 1317 coupled to the seat shell 1311, a first side wing 1324 coupled to a first lateral side 1323 of the backrest 1318 and projecting forward therefrom, and a second side wing 1326 coupled to a second lateral side 1325 of the backrest and projecting forward therefrom. The child-restraint harness 1317 is configured to restrain the child in the child-receiving space 1316. Each side wing 1324, 1326 is formed to include a shoulder-receiving side-impact recess 1328, 1330. The shoulder-receiving side-impact recess 1328, 1330 of the first side wing 1324 or the second side wing 1326 is configured to receive the shoulder and/or arm region of the child during the side impact event.

A lowermost end 1350 of the recess 1328, 1330 is located within 125 mm of a seat bottom plane 1352 established by a seating surface 1354 of the seat bottom 1312. In some embodiments, the lowermost end 1350 of the recess 1328, 1330 is located within 115 mm of the seat bottom plane 1352. In some embodiments, the lowermost end 1350 of the recess 1328, 1330 is located within 110 mm of the seat bottom plane 1352. In some embodiments, the lowermost end 1350 of the recess 1328, 1330 is located about (i.e. within 10 mm) 100 mm of the seat bottom plane 1352. Such spacing provides sufficient distance to receive the arm region of the child while providing a lower panel to engage the hip region of the child.

An uppermost end 1356 of the recess 1328, 1330 is located at least 400 mm from the seat bottom plane 1352. In some embodiments, the uppermost end 1356 is located at least 425 mm from the seat bottom plane 1352. In some embodiments, the uppermost end 1356 is located at least 450 mm from the seat bottom plane 1352. In some embodiments, the uppermost end 1356 is located at least 475 mm from the seat bottom plane 1352. In some embodiments, the uppermost end 1356 is located about (i.e., within 10 mm) 525 mm from the seat bottom plane 1352. Such spacing provides sufficient distance to receive the shoulder and/or arm region of the child while providing an upper panel to support the head region of the child across a wide range of heights of the child.

The uppermost end 1356 of the recess 1328, 1330 is located within 50 mm of a reference point R located about (i.e. within 10 mm) 460 mm from the seat bottom plane 1352. The reference point R represents a center of gravity of a head of a 3 year old test dummy sized according to Subpart W from 49 CFR part 572 at the time of filing this application.

Each side wing 1324, 1326 is formed to include a belt path opening 1376 located between the backrest 1318 and the recess 1328, 1330. A rearmost end 1358 of the recess 1328, 1330 is spaced a distance from a seating surface 1360 provided by the seat back 1314 within a range of about 25 mm to about 75 mm. Each recess 1328, 1330 has a width from an innermost end 1362 to a medial side-impact barrier surface 1380 of at least 50 mm. In some embodiments, the recess 1328, 1330 has a width of at least 50 mm. In some embodiments, the recess 1328, 1330 has a width of about (i.e. within 10 mm) 50 mm. Such dimensions provide sufficient spacing for the shoulder and/or arm region of the child to move laterally during a side impact event to minimize chest displacement.

Each recess 1328, 1330 has a depth from the rearmost end 1358 to a forwardmost end 1382 of at least 75 mm. In some embodiments, the recess 1328, 1330 has a depth of at least 100 mm. In some embodiments, the recess 1328, 1330 has a depth of about (i.e. within 10 mm) 165 mm. Such dimensions provide sufficient forward projection of the side wings 1324, 1326 to restrain the shoulder and/or arm region of the child.

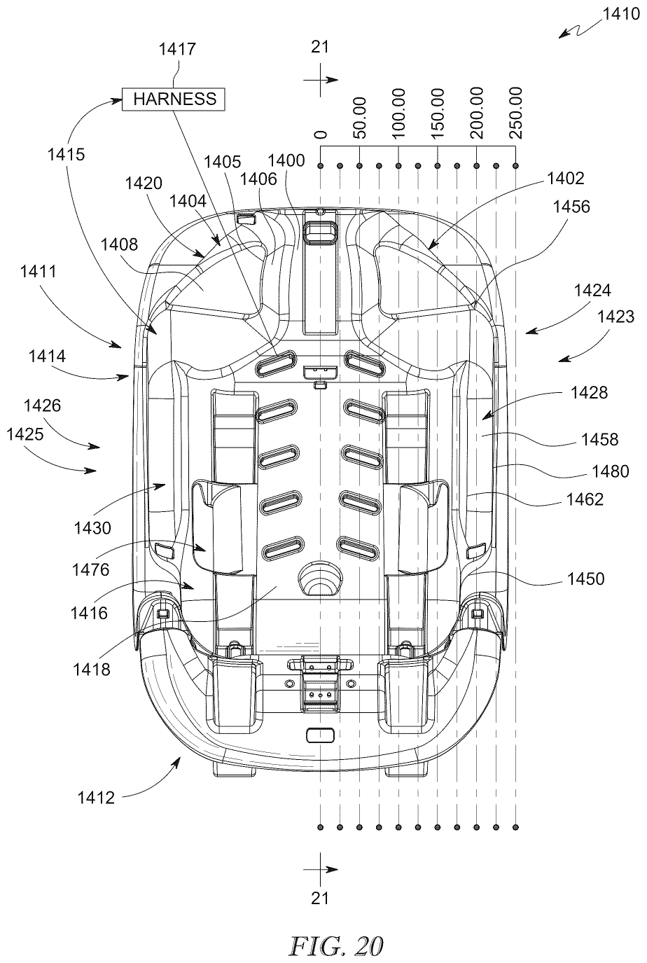

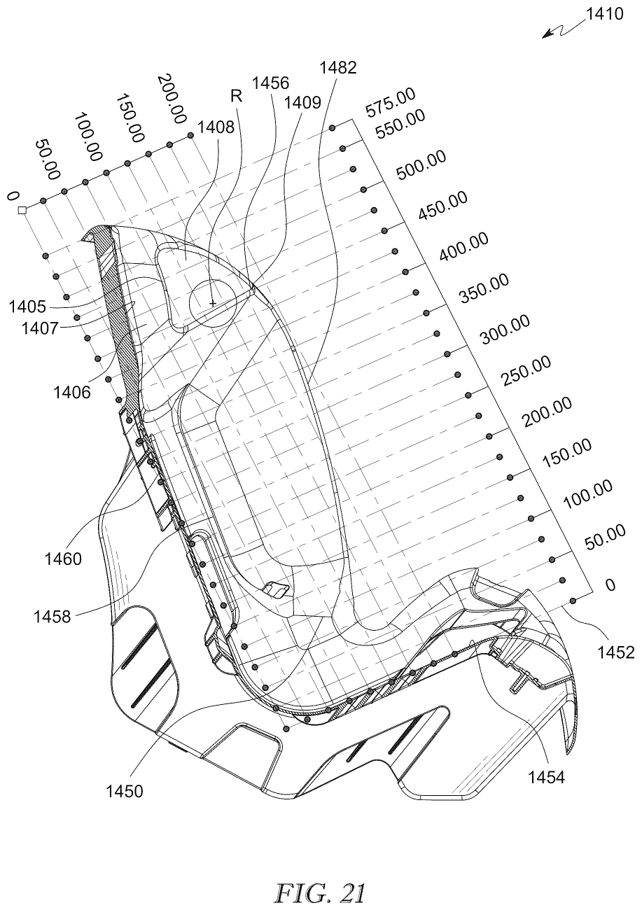

FIGS. 20 and 21 show a seventh embodiment of a child restraint 1410 including recesses 1428, 1430 in side wings 1424, 1426 of backrest 1418. Child restraint 1410 is substantially similar to child restraint 10. Accordingly the disclosure of child restraint 10 is hereby incorporated herein for child restraint 1410.

Child restraint 1410 includes a seat shell 1411 and is formed to include a child-receiving space 1416 configured to hold a child for transportation in a vehicle. The seat shell 1411 includes a seat bottom 1412 and a seat back 1414 coupled to the seat bottom 1412. The seat back 1414 includes a backrest 1418 extending upwardly away from the seat bottom 1412 and a headrest 1420 coupled to the backrest 1418. The seat bottom 1412 and the seat back 1414 at least partially define the child-receiving space 1416.

The headrest 1420 includes a rear section 1400, a first side section 1402, and a second side section 1404. The rear section 1400 extends between and interconnects the first and second side section 1402, 1404 and is configured to support the back of a child's head seated on the child restraint 1410. The first side section 1402 extends outwardly away from the rear section 1400 on a first lateral side of the headrest 1420. The second side section 1404 extends outwardly away from the rear section 1400 on a second, opposite lateral side of the headrest 1420 and is spaced apart from the first side section 1402.

The first and second side sections 1402, 1404 of the headrest 1420 are configured to reduce forces acting on the head of a child during side impacts, for example. Each side section 1402, 1404 includes an outer surface facing toward the head of a child. The outer surface of each side section 1402, 1404 varies in distance from one another to interact with the head of the child and reduce forces acting on the head of the child as the head contacts either outer surface. In some embodiments, the outer surface of each side section 1402, 1404 provides energy-redirection means to cause the head of the child to roll and/or turn as the head engages the side section 1402, 1404 during a side impact.

The outer surface of each side section 1402, 1404 includes a first energy-absorption surface 1406 coupled to the rear section 1400 and a second energy-absorption surface 1408 coupled to a distal end of the first energy-absorption surface 1406 and spaced apart from the rear section 1400. A transition point 1405 is located between the first and second energy-absorption surfaces 1406, 1408 in each side section 1402, 1404. The transition point 1405 is spaced apart from a centerline of the headrest 1420 between the first and second side sections 1402, 1404 by a width distance within a range of 60 mm and 100 mm. In some embodiments, the width distance is within a range of 70 mm to 90 mm. In some embodiments, the width distance is about 75 mm. In some embodiments, the width distance is no more than 100 mm and/or no less than 70 mm.

The transition point 1405 is also spaced apart from a seating surface 1407 provided by the rear section 1400 of the headrest 1420 by a depth distance of 25 mm to 75 mm. In some embodiments, the depth distance is within a range of 40 mm to 60 mm. In some embodiments, the depth distance is about 50 mm.

The transition point 1405 is also spaced apart from a reference point R by a distance of 15 mm to 50 mm. In some embodiments, the distance is within a range of 20 mm to 45 mm. In some embodiments, the distance is about 40 mm. In the illustrative embodiment, the reference point R is located in front of the transition point 1405. Positioning the transition point 1405 rearward of the reference point R aligns the reference point R with the second energy-absorption surface and causes a region of the head rearward of the transition point 1405 to contact the first energy-absorption surface 1406 first during the side impact so that the first and second energy-absorption surfaces cooperate to induce head roll along the side section and disperse forces.

The first energy-absorption surface 1406 and the second energy-absorption surface 1408 have a depth ratio (i.e. depth distance from surface 1407 to transition point 1405 divided by depth distance from transition point 1405 to distal end 1409 of surface 1408) within a range of 0.4 to 1.1. In some embodiments, the depth ratio is within a range of 0.5 to 1. In some embodiments, the depth ratio is within a range of 0.6 to 0.9. In some embodiments, the depth ratio is about 0.8. These distances and ratio provide the headrest 1420 with energy-redirection means to cause the head of the child to contact the first energy-absorption surface 1406 first during a side impact and then maintain contact with one of the side sections 1402, 1404 during the side impact to cause the head of the child to roll along the first energy-absorption surface 1406 and then the second energy-absorption surface 1408 to disperse forces on the child's head over a larger distance and/or surface area thereby reducing the cumulative force experienced by the child's head.

In illustrative embodiments, the child restraint 1410 further includes a side-impact management system 1415 coupled to at least one of the seat bottom 1412 and the seat back 1414. The side-impact management system 1415 is configured to provide means for managing chest displacement of the child during a side impact to reduce a lateral force on a shoulder region of the child during the side impact so that chest displacement of the child is minimized.

The side-impact management system 1415 includes a child-restraint harness 1417 coupled to the seat shell 1411, a first side wing 1424 coupled to a first lateral side 1423 of the backrest 1418 and projecting forward therefrom, and a second side wing 1426 coupled to a second lateral side 1425 of the backrest and projecting forward therefrom. The child-restraint harness 1417 is configured to restrain the child in the child-receiving space 1416. Each side wing 1424, 1426 is formed to include a shoulder-receiving side-impact recess 1428, 1430. The shoulder-receiving side-impact recess 1428, 1430 of the first side wing 1424 or the second side wing 1426 is configured to receive the shoulder and/or arm region of the child during the side impact event.

A lowermost end 1450 of the recess 1428, 1430 is located within 125 mm of a seat bottom plane 1452 established by a seating surface 1454 of the seat bottom 1412. In some embodiments, the lowermost end 1450 of the recess 1428, 1430 is located within 115 mm of the seat bottom plane 1252. In some embodiments, the lowermost end 1450 of the recess 1428, 1430 is located within 110 mm of the seat bottom plane 1452. In some embodiments, the lowermost end 1450 of the recess 1428, 1430 is located about (i.e. within 10 mm) 100 mm of the seat bottom plane 1452. Such spacing provides sufficient distance to receive the arm region of the child while providing a lower panel to engage the hip region of the child.

An uppermost end 1456 of the recess 1428, 1430 is located at least 400 mm from the seat bottom plane 1452. In some embodiments, the uppermost end 1456 is located at least 425 mm from the seat bottom plane 1452. In some embodiments, the uppermost end 1456 is located at least 450 mm from the seat bottom plane 1452. In some embodiments, the uppermost end 1456 is located at least 475 mm from the seat bottom plane 1452. In some embodiments, the uppermost end 1456 is located about (i.e. within 10 mm) 450 mm from the seat bottom plane 1452. Such spacing provides sufficient distance to receive the shoulder and/or arm region of the child while providing an upper panel to support the head region of the child across a wide range of heights of the child.

The uppermost end 1456 of the recess 1428, 1430 is located within 50 mm of a reference point R located about (i.e. within 10 mm) 460 mm from the seat bottom plane 1452. The reference point R represents a center of gravity of a head of a 3 year old test dummy sized according to Subpart W from 49 CFR part 572 at the time of filing this application.

Each side wing 1424, 1426 is formed to include a belt path opening 1476 located between the backrest 1418 and the recess 1428, 1430. A rearmost end 1458 of the recess 1428, 1430 is spaced a distance from a seating surface 1460 provided by the seat back 1414 within a range of about 25 mm to about 75 mm. Each recess 1428, 1430 has a width from an innermost end 1462 to a medial side-impact barrier surface 1480 of at least 50 mm. In some embodiments, the recess 1428, 1430 has a width of at least 75 mm. In some embodiments, the recess 1428, 1430 has a width of about (i.e. within 10 mm) 50 mm. Such dimensions provide sufficient spacing for the shoulder and/or arm region of the child to move laterally during a side impact event to minimize chest displacement.

Each recess 1428, 1430 has a depth from the rearmost end 1458 to a forwardmost end 1482 of at least 75 mm. In some embodiments, the recess 1428, 1430 has a depth of at least 100 mm. In some embodiments, the recess 1428, 1430 has a depth of about (i.e. within 10 mm) 140 mm. Such dimensions provide sufficient forward projection of the side wings 1424, 1426 to restrain the shoulder and/or arm region of the child.

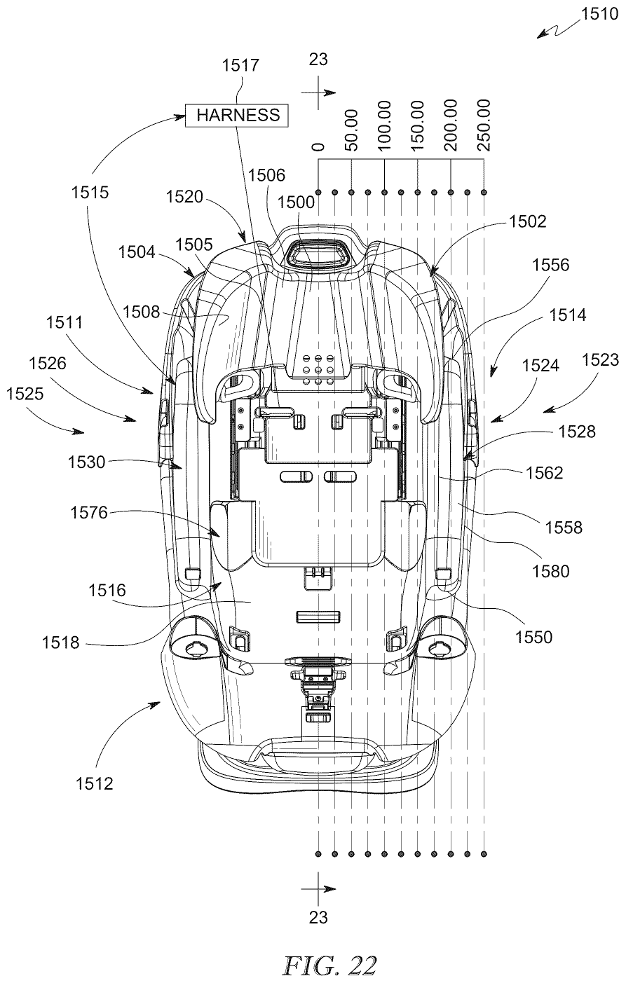

FIGS. 22-24 show a eighth embodiment of a child restraint 1510 including recesses 1528, 1530 in side wings 1524, 1526 of backrest 1518. Child restraint 1510 is similar to child restraint 10. Accordingly the disclosure of child restraint 10 is hereby incorporated herein for child restraint 1510.

Child restraint 1510 includes a seat shell 1511 and is formed to include a child-receiving space 1516 configured to hold a child for transportation in a vehicle. The seat shell 1511 includes a seat bottom 1512 and a seat back 1514 coupled to the seat bottom 1512. The seat back 1514 includes a backrest 1518 extending upwardly away from the seat bottom 1512 and a headrest 1520 coupled to the backrest 1518. The seat bottom 1512 and the seat back 1514 at least partially define the child-receiving space 1516.

The headrest 1520 includes a rear section 1500, a first side section 1502, and a second side section 1504. The rear section 1500 extends between and interconnects the first and second side section 1502, 1504 and is configured to support the back of a child's head seated on the child restraint 1510. The first side section 1502 extends outwardly away from the rear section 1500 on a first lateral side of the headrest 1520. The second side section 1504 extends outwardly away from the rear section 1500 on a second, opposite lateral side of the headrest 1520 and is spaced apart from the first side section 1502. In some embodiments, the headrest 1520 can be integrally formed with the backrest 1518 and coupled to an upper end of the backrest 1518.

The first and second side sections 1502, 1504 of the headrest 1520 are configured to reduce forces acting on the head of a child during side impacts, for example. Each side section 1502, 1504 includes an outer surface facing toward the head of a child. The outer surface of each side section 1502, 1504 varies in distance from one another to interact with the head of the child and reduce forces acting on the head of the child as the head contacts either outer surface. In some embodiments, the outer surface of each side section 1502, 1504 provides energy-redirection means to cause the head of the child to roll and/or turn as the head engages the side section 1502, 1504 during a side impact.

The outer surface of each side section 1502, 1504 includes a first energy-absorption surface 1506 coupled to the rear section 1500 and a second energy-absorption surface 1508 coupled to a distal end of the first energy-absorption surface 1506 and spaced apart from the rear section 1500. A transition point 1505 is located between the first and second energy-absorption surfaces 1206, 1208 in each side section 1502, 1504. The transition point 1505 is spaced apart from a centerline of the headrest 1520 between the first and second side sections 1502, 1504 by a width distance within a range of 50 mm and 90 mm. In some embodiments, the width distance is within a range of 60 mm to 80 mm. In some embodiments, the width distance is about 75 mm. In some embodiments, the width distance is no more than 90 mm and/or no less than 60 mm.

The transition point 1505 is also spaced apart from a seating surface 1507 provided by the rear section 1500 of the headrest 1520 by a depth distance of 50 mm to 90 mm. In some embodiments, the depth distance is within a range of 60 mm to 75 mm. In some embodiments, the depth distance is about 65 mm.

The transition point 1505 is also spaced apart from a reference point R by a distance of 15 mm to 40 mm. In some embodiments, the distance is within a range of 20 mm to 30 mm. In some embodiments, the distance is about 25 mm. In the illustrative embodiment, the reference point R is located in front of the transition point 1505. Positioning the transition point 1505 rearward of the reference point R aligns the reference point R with the second energy-absorption surface and causes a region of the head rearward of the transition point 1505 to contact the first energy-absorption surface 1506 first during the side impact so that the first and second energy-absorption surfaces cooperate to induce head roll along the side section and disperse forces.

The first energy-absorption surface 1506 and the second energy-absorption surface 1508 have a depth ratio (i.e. depth distance from surface 1507 to transition point 1505 divided by depth distance from transition point 1505 to distal end 1509 of surface 1508) within a range of 0.7 to 1.3. In some embodiments, the depth ratio is within a range of 0.3 to 1.1. In some embodiments, the depth ratio is within a range of 0.4 to 0.9. In some embodiments, the depth ratio is about 0.6. These distances and ratio provide the headrest 1520 with energy-redirection means to cause the head of the child to contact the first energy-absorption surface 1506 first during a side impact and then maintain contact with one of the side sections 1502, 1504 during the side impact to cause the head of the child to roll along the first energy-absorption surface 1506 and then the second energy-absorption surface 1508 to disperse forces on the child's head over a larger distance and/or surface area thereby reducing the cumulative force experienced by the child's head.

In illustrative embodiments, the child restraint 1510 further includes a side-impact management system 1515 coupled to at least one of the seat bottom 1512 and the seat back 1514. The side-impact management system 1515 is configured to provide means for managing chest displacement of the child during a side impact to reduce a lateral force on a shoulder region of the child during the side impact so that chest displacement of the child is minimized.

The side-impact management system 1515 includes a child-restraint harness 1517 coupled to the seat shell 1511, a first side wing 1524 coupled to a first lateral side 1523 of the backrest 1518 and projecting forward therefrom, and a second side wing 1526 coupled to a second lateral side 1525 of the backrest and projecting forward therefrom. The child-restraint harness 1517 is configured to restrain the child in the child-receiving space 1516. Each side wing 1524, 1526 is formed to include a shoulder-receiving side-impact recess 1528, 1530. The shoulder-receiving side-impact recess 1528, 1530 of the first side wing 1524 or the second side wing 1526 is configured to receive the shoulder and/or arm region of the child during the side impact event.

A lowermost end 1550 of the recess 1528, 1530 is located within 125 mm of a seat bottom plane 1552 established by a seating surface 1554 of the seat bottom 1512. In some embodiments, the lowermost end 1550 of the recess 1528, 1530 is located within 115 mm of the seat bottom plane 1552. In some embodiments, the lowermost end 1550 of the recess 1528, 1530 is located within 110 mm of the seat bottom plane 1552. In some embodiments, the lowermost end 1550 of the recess 1528, 1530 is located about (i.e. within 10 mm) 100 mm of the seat bottom plane 1552. Such spacing provides sufficient distance to receive the arm region of the child while providing a lower panel to engage the hip region of the child.

An uppermost end 1556 of the recess 1528, 1530 is located at least 400 mm from the seat bottom plane 1552. In some embodiments, the uppermost end 1556 is located at least 425 mm from the seat bottom plane 1552. In some embodiments, the uppermost end 1556 is located at least 450 mm from the seat bottom plane 1552. In some embodiments, the uppermost end 1556 is located at least 475 mm from the seat bottom plane 1552. In some embodiments, the uppermost end 1556 is located about (i.e. within 10 mm) 500 mm from the seat bottom plane 1552. Such spacing provides sufficient distance to receive the shoulder and/or arm region of the child while providing an upper panel to support the head region of the child across a wide range of heights of the child.

The uppermost end 1556 of the recess 1528, 1530 is located within 50 mm of a reference point R located about (i.e. within 10 mm) 460 mm from the seat bottom plane 1552. The reference point R represents a center of gravity of a head of a 3 year old test dummy sized according to Subpart W from 49 CFR part 572 at the time of filing this application.

Each side wing 1524, 1526 is formed to include a belt path opening 1576 located between the backrest 1518 and the recess 1528, 1530. A rearmost end 1558 of the recess 1528, 1530 is spaced a distance from a seating surface 1560 provided by the seat back 1514 within a range of about 25 mm to about 75 mm. Each recess 1528, 1530 has a width from an innermost end 1562 to a medial side-impact barrier surface 1580 of at least 50 mm. In some embodiments, the recess 1528, 1530 has a width of at least 50 mm. In some embodiments, the recess 1528, 1530 has a width of about (i.e. within 10 mm) 50 mm. Such dimensions provide sufficient spacing for the shoulder and/or arm region of the child to move laterally during a side impact event to minimize chest displacement.

Each recess 1528, 1530 has a depth from the rearmost end 1558 to a forwardmost end 1582 of at least 75 mm. In some embodiments, the recess 1528, 1530 has a depth of at least 100 mm. In some embodiments, the recess 1528, 1530 has a depth of about (i.e. within 10 mm) 100 mm. Such dimensions provide sufficient forward projection of the side wings 1524, 1526 to restrain the shoulder and/or arm region of the child.

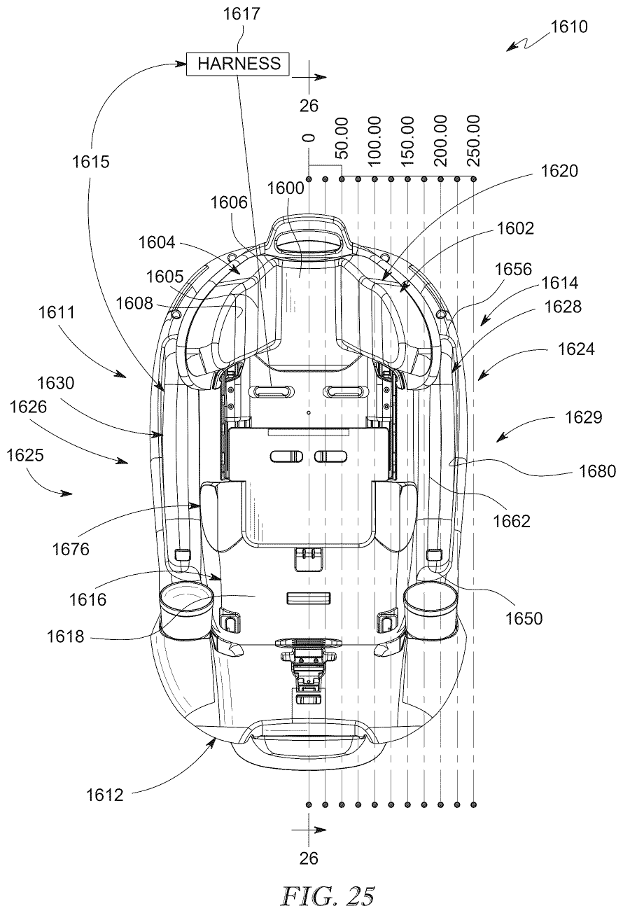

FIGS. 25-27 show a nineth embodiment of a child restraint 1610 including recesses 1628, 1630 in side wings 1624, 1626 of backrest 1618. Child restraint 1610 is similar to child restraint 10. Accordingly the disclosure of child restraint 10 is hereby incorporated herein for child restraint 1610.

Child restraint 1610 includes a seat shell 1611 and is formed to include a child-receiving space 1616 configured to hold a child for transportation in a vehicle. The seat shell 1611 includes a seat bottom 1612 and a seat back 1614 coupled to the seat bottom 1612. The seat back 1614 includes a backrest 1618 extending upwardly away from the seat bottom 1612 and a headrest 1620 coupled to the backrest 1618. The seat bottom 1612 and the seat back 1614 at least partially define the child-receiving space 1616.

The headrest 1620 includes a rear section 1600, a first side section 1602, and a second side section 1604. The rear section 1600 extends between and interconnects the first and second side section 1602, 1604 and is configured to support the back of a child's head seated on the child restraint 1610. The first side section 1602 extends outwardly away from the rear section 1600 on a first lateral side of the headrest 1620. The second side section 1604 extends outwardly away from the rear section 1600 on a second, opposite lateral side of the headrest 1620 and is spaced apart from the first side section 1602. In some embodiments, the headrest 1620 can be integrally formed with the backrest 1618 and coupled to an upper end of the backrest 1618.

The first and second side sections 1602, 1604 of the headrest 1620 are configured to reduce forces acting on the head of a child during side impacts, for example. Each side section 1602, 1604 includes an outer surface facing toward the head of a child. The outer surface of each side section 1602, 1604 varies in distance from one another to interact with the head of the child and reduce forces acting on the head of the child as the head contacts either outer surface. In some embodiments, the outer surface of each side section 1602, 1604 provides energy-redirection means to cause the head of the child to roll and/or turn as the head engages the side section 1602, 1604 during a side impact.

The outer surface of each side section 1602, 1604 includes a first energy-absorption surface 1606 coupled to the rear section 1600 and a second energy-absorption surface 1608 coupled to a distal end of the first energy-absorption surface 1606 and spaced apart from the rear section 1600. A transition point 1605 is located between the first and second energy-absorption surfaces 1606, 1608 in each side section 1602, 1604. The transition point 1605 is spaced apart from a centerline of the headrest 1620 between the first and second side sections 1602, 1604 by a width distance within a range of 40 mm and 90 mm. In some embodiments, the width distance is within a range of 60 mm to 80 mm. In some embodiments, the width distance is about 75 mm. In some embodiments, the width distance is no more than 90 mm and/or no less than 60 mm.

The transition point 1605 is also spaced apart from a seating surface 1607 provided by the rear section 1600 of the headrest 1620 by a depth distance of 30 mm to 70 mm. In some embodiments, the depth distance is within a range of 40 mm to 60 mm. In some embodiments, the depth distance is about 50 mm.

The transition point 1605 is also spaced apart from a reference point R by a distance of 20 mm to 60 mm. In some embodiments, the distance is within a range of 30 mm to 50 mm. In some embodiments, the distance is about 40 mm. In the illustrative embodiment, the reference point R is located in front of the transition point 1605. Positioning the transition point 1605 rearward of the reference point R aligns the reference point R with the second energy-absorption surface and causes a region of the head rearward of the transition point 1605 to contact the first energy-absorption surface 1606 first during the side impact so that the first and second energy-absorption surfaces cooperate to induce head roll along the side section and disperse forces.

The first energy-absorption surface 1606 and the second energy-absorption surface 1608 have a depth ratio (i.e. depth distance from surface 1607 to transition point 1605 divided by depth distance from transition point 1605 to distal end 1609 of surface 1608) within a range of 0.3 to 1. In some embodiments, the depth ratio is within a range of 0.4 to 0.8. In some embodiments, the depth ratio is within a range of 0.5 to 0.7. In some embodiments, the depth ratio is about 0.65. These distances and ratio provide the headrest 1620 with energy-redirection means to cause the head of the child to contact the first energy-absorption surface 1606 first during a side impact and then maintain contact with one of the side sections 1602, 1604 during the side impact to cause the head of the child to roll along the first energy-absorption surface 1606 and then the second energy-absorption surface 1608 to disperse forces on the child's head over a larger distance and/or surface area thereby reducing the cumulative force experienced by the child's head.

In illustrative embodiments, the child restraint 1610 further includes a side-impact management system 1615 coupled to at least one of the seat bottom 1612 and the seat back 1614. The side-impact management system 1615 is configured to provide means for managing chest displacement of the child during a side impact to reduce a lateral force on a shoulder region of the child during the side impact so that chest displacement of the child is minimized.

The side-impact management system 1615 includes a child-restraint harness 1617 coupled to the seat shell 1611, a first side wing 1624 coupled to a first lateral side 1623 of the backrest 1618 and projecting forward therefrom, and a second side wing 1626 coupled to a second lateral side 1625 of the backrest and projecting forward therefrom. The child-restraint harness 1617 is configured to restrain the child in the child-receiving space 1616. Each side wing 1624, 1626 is formed to include a shoulder-receiving side-impact recess 1628, 1630. The shoulder-receiving side-impact recess 1628, 1630 of the first side wing 1624 or the second side wing 1626 is configured to receive the shoulder and/or arm region of the child during the side impact event.

A lowermost end 1650 of the recess 1628, 1630 is located within 125 mm of a seat bottom plane 1652 established by a seating surface 1654 of the seat bottom 1612. In some embodiments, the lowermost end 1650 of the recess 1628, 1630 is located within 115 mm of the seat bottom plane 1652. In some embodiments, the lowermost end 1650 of the recess 1628, 1630 is located within 110 mm of the seat bottom plane 1652. In some embodiments, the lowermost end 1650 of the recess 1628, 1630 is located about (i.e. within 10 mm) 100 mm of the seat bottom plane 1652. Such spacing provides sufficient distance to receive the arm region of the child while providing a lower panel to engage the hip region of the child.

An uppermost end 1656 of the recess 1628, 1630 is located at least 400 mm from the seat bottom plane 1652. In some embodiments, the uppermost end 1656 is located at least 425 mm from the seat bottom plane 1652. In some embodiments, the uppermost end 1656 is located at least 450 mm from the seat bottom plane 1652. In some embodiments, the uppermost end 1656 is located at least 460 mm from the seat bottom plane 1652. In some embodiments, the uppermost end 1656 is located about (i.e. within 10 mm) 465 mm from the seat bottom plane 1652. Such spacing provides sufficient distance to receive the shoulder and/or arm region of the child while providing an upper panel to support the head region of the child across a wide range of heights of the child.

The uppermost end 1656 of the recess 1628, 1630 is located within 50 mm of a reference point R located about (i.e. within 10 mm) 460 mm from the seat bottom plane 1652. The reference point R represents a center of gravity of a head of a 3 year old test dummy sized according to Subpart W from 49 CFR part 572 at the time of filing this application.

Each side wing 1624, 1626 is formed to include a belt path opening 1676 located between the backrest 1618 and the recess 1628, 1630. A rearmost end 1658 of the recess 1628, 1630 is spaced a distance from a seating surface 1660 provided by the backrest 1618 within a range of about 25 mm to about 75 mm. Each recess 1628, 1630 has a width from the rearmost end 1658 to a medial side-impact barrier surface 1680 of at least 50 mm. In some embodiments, the recess 1628, 1630 has a width of at least 50 mm. In some embodiments, the recess 1628, 1630 has a width of about (i.e. within 10 mm) 50 mm. Such dimensions provide sufficient spacing for the shoulder and/or arm region of the child to move laterally during a side impact event to minimize chest displacement.

Each recess 1628, 1630 has a depth from the rearmost end 1658 to a forwardmost end 1682 of at least 75 mm. In some embodiments, the recess 1628, 1630 has a depth of at least 100 mm. In some embodiments, the recess 1628, 1630 has a depth of about (i.e. within 10 mm) 75 mm. Such dimensions provide sufficient forward projection of the side wings 1624, 1626 to restrain the shoulder and/or arm region of the child.

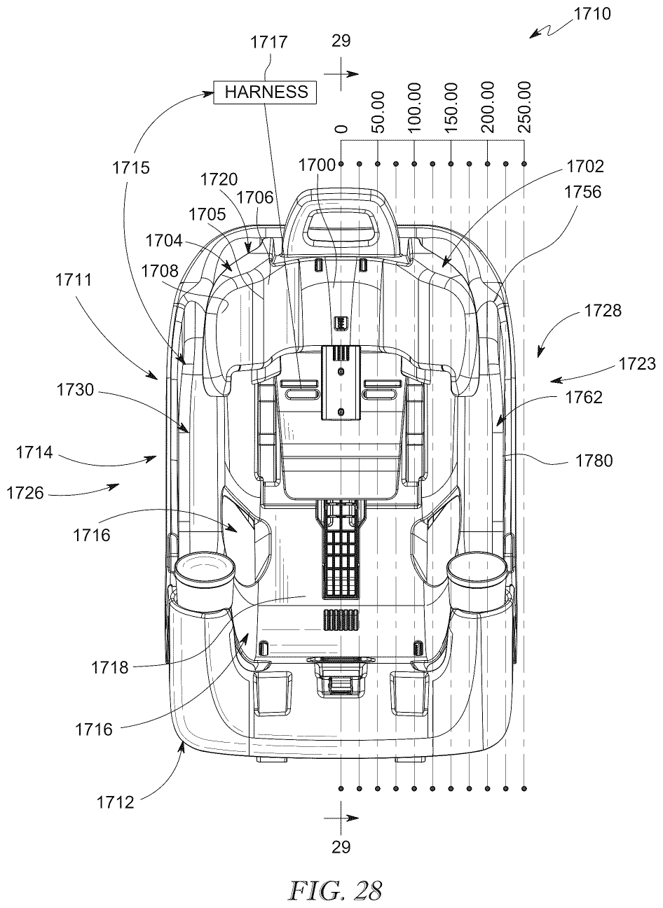

FIGS. 28-30 show a tenth embodiment of a child restraint 1710 including recesses 1728, 1730 in side wings 1724, 1726 of backrest 1718. Child restraint 1710 is similar to child restraint 10. Accordingly the disclosure of child restraint 10 is hereby incorporated herein for child restraint 1710.

Child restraint 1710 includes a seat shell 1711 and is formed to include a child-receiving space 1716 configured to hold a child for transportation in a vehicle. The seat shell 1711 includes a seat bottom 1712 and a seat back 1714 coupled to the seat bottom 1712. The seat back 1714 includes a backrest 1718 extending upwardly away from the seat bottom 1712 and a headrest 1720 coupled to the backrest 1718. The seat bottom 1712 and the seat back 1714 at least partially define the child-receiving space 1716.

The headrest 1720 includes a rear section 1700, a first side section 1702, and a second side section 1704. The rear section 1700 extends between and interconnects the first and second side section 1702, 1704 and is configured to support the back of a child's head seated on the child restraint 1710. The first side section 1702 extends outwardly away from the rear section 1700 on a first lateral side of the headrest 1720. The second side section 1704 extends outwardly away from the rear section 1700 on a second, opposite lateral side of the headrest 1720 and is spaced apart from the first side section 1702. In some embodiments, the headrest 1720 can be integrally formed with the backrest 1718 and coupled to an upper end of the backrest 1718.

The first and second side sections 1702, 1704 of the headrest 1720 are configured to reduce forces acting on the head of a child during side impacts, for example. Each side section 1702, 1704 includes an outer surface facing toward the head of a child. The outer surface of each side section 1702, 1704 varies in distance from one another to interact with the head of the child and reduce forces acting on the head of the child as the head contacts either outer surface. In some embodiments, the outer surface of each side section 1702, 1704 provides energy-redirection means to cause the head of the child to roll and/or turn as the head engages the side section 1702, 1704 during a side impact.

The outer surface of each side section 1702, 1704 includes a first energy-absorption surface 1706 coupled to the rear section 1700 and a second energy-absorption surface 1708 coupled to a distal end of the first energy-absorption surface 1706 and spaced apart from the rear section 1700. A transition point 1705 is located between the first and second energy-absorption surfaces 1706, 1708 in each side section 1702, 1704. The transition point 1705 is spaced apart from a centerline of the headrest 1720 between the first and second side sections 1702, 1704 by a width distance within a range of 80 mm and 130 mm. In some embodiments, the width distance is within a range of 90 mm to 115 mm. In some embodiments, the width distance is about 105 mm. In some embodiments, the width distance is no more than 110 mm and/or no less than 95 mm.

The transition point 1705 is also spaced apart from a seating surface 1707 provided by the rear section 1700 of the headrest 1720 by a depth distance of 80 mm to 120 mm. In some embodiments, the depth distance is within a range of 90 mm to 110 mm. In some embodiments, the depth distance is about 100 mm.

The transition point 1705 is also spaced apart from a reference point R by a distance of 0 mm to 25 mm. In some embodiments, the distance is within a range of 0 mm to 15 mm. In some embodiments, the distance is about 5 mm. In the illustrative embodiment, the reference point R is located rearward of the transition point 1705.

The first energy-absorption surface 1706 and the second energy-absorption surface 1708 have a depth ratio (i.e. depth distance from surface 1707 to transition point 1705 divided by depth distance from transition point 1705 to distal end 1709 of surface 1708) within a range of 1 to 2.5. In some embodiments, the depth ratio is within a range of 1.5 to 2.25. In some embodiments, the depth ratio is within a range of 1.8 to 2.1. In some embodiments, the depth ratio is about 2. These distances and ratio provide the headrest 1720 with energy-redirection means to cause the head of the child to contact the first energy-absorption surface 1706 first during a side impact and then maintain contact with one of the side sections 1702, 1704 during the side impact to cause the head of the child to roll along the first energy-absorption surface 1706 and then the second energy-absorption surface 1708 to disperse forces on the child's head over a larger distance and/or surface area thereby reducing the cumulative force experienced by the child's head.

In illustrative embodiments, the child restraint 1710 further includes a side-impact management system 1715 coupled to at least one of the seat bottom 1712 and the seat back 1714. The side-impact management system 1715 is configured to provide means for managing chest displacement of the child during a side impact to reduce a lateral force on a shoulder region of the child during the side impact so that chest displacement of the child is minimized.

The side-impact management system 1715 includes a child-restraint harness 1717 coupled to the seat shell 1711, a first side wing 1724 coupled to a first lateral side 1723 of the backrest 1718 and projecting forward therefrom, and a second side wing 1726 coupled to a second lateral side 1725 of the backrest and projecting forward therefrom. The child-restraint harness 1717 is configured to restrain the child in the child-receiving space 1716. Each side wing 1724, 1726 is formed to include a shoulder-receiving side-impact recess 1728, 1730. The shoulder-receiving side-impact recess 1728, 1730 of the first side wing 1724 or the second side wing 1726 is configured to receive the shoulder and/or arm region of the child during the side impact event.

A lowermost end 1750 of the recess 1728, 1730 is located within 125 mm of a seat bottom plane 1752 established by a seating surface 1754 of the seat bottom 1712. In some embodiments, the lowermost end 1750 of the recess 1728, 1730 is located within 115 mm of the seat bottom plane 1752. In some embodiments, the lowermost end 1750 of the recess 1728, 1730 is located within 110 mm of the seat bottom plane 1752. In some embodiments, the lowermost end 1750 of the recess 1728, 1730 is located about (i.e. within 10 mm) 100 mm of the seat bottom plane 1752. Such spacing provides sufficient distance to receive the arm region of the child while providing a lower panel to engage the hip region of the child.

An uppermost end 1756 of the recess 1728, 1730 is located at least 400 mm from the seat bottom plane 1752. In some embodiments, the uppermost end 1756 is located at least 425 mm from the seat bottom plane 1752. In some embodiments, the uppermost end 1756 is located at least 450 mm from the seat bottom plane 1752. In some embodiments, the uppermost end 1756 is located at least 475 mm from the seat bottom plane 1752. In some embodiments, the uppermost end 1756 is located about (i.e. within 10 mm) 480 mm from the seat bottom plane 1752. Such spacing provides sufficient distance to receive the shoulder and/or arm region of the child while providing an upper panel to support the head region of the child across a wide range of heights of the child.

The uppermost end 1756 of the recess 1728, 1730 is located within 50 mm of a reference point R located about (i.e. within 10 mm) 460 mm from the seat bottom plane 1752. The reference point R represents a center of gravity of a head of a 3 year old test dummy sized according to Subpart W from 49 CFR part 572 at the time of filing this application.

Each side wing 1724, 1726 is formed to include a belt path opening 1776 located between the backrest 1718 and the recess 1728, 1730. A rearmost end 1758 of the recess 1728, 1730 is spaced a distance from a seating surface 1760 provided by the backrest 1718 within a range of about 25 mm to about 75 mm. Each recess 1728, 1730 has a width from the rearmost end 1758 to a medial side-impact barrier surface 1780 of at least 50 mm. In some embodiments, the recess 1728, 1730 has a width of at least 50 mm. In some embodiments, the recess 1728, 1730 has a width of about (i.e. within 10 mm) 60 mm. Such dimensions provide sufficient spacing for the shoulder and/or arm region of the child to move laterally during a side impact event to minimize chest displacement.

Each recess 1728, 1730 has a depth from the rearmost end 1758 to a forwardmost end 1782 of at least 75 mm. In some embodiments, the recess 1728, 1730 has a depth of at least 100 mm. In some embodiments, the recess 1728, 1730 has a depth of about (i.e. within 10 mm) 100 mm. Such dimensions provide sufficient forward projection of the side wings 1724, 1726 to restrain the shoulder and/or arm region of the child.

Child restraints with an integral headrest, such as child restraint 10, 210, 310, and 1410 may have headrest regions with a smaller depth in comparison to child restraints with a movable headrest, such as child restraint 1110, 1210, 1310, 1510, 1610, 1710. This is because a greater depth may be needed to accommodate mechanisms for adjusting the headrest relative to the backrest (i.e. a handle, locking components additional covers, etc.) This can result in a seating surface of the headrest being offset forward from a seating surface of the rear wall of the backrest. The offset may cause the head of the child to be shifted forward relative to the rear wall of the backrest. As a result, the transition point may be positioned closer to the reference point R in child restraints with a movable headrest compared to child restraints with an integral headrest. In some embodiments, child restraints with movable headrests have a transition point at least 25 mm closer to the reference point R in comparison with child restraints with an integral headrest.

Child restraints with an integral headrest may include soft goods and/or trim covering the backrest and the headrest, but may lack any foam between the soft goods and the seat shell. Child restraints with a movable headrest may include soft goods and/or trim covering the backrest and a separate soft goods and/or trim covering the headrest to allow movement of the headrest relative to the rest of the child restraint. Child restraints with a movable headrest may further include a layer of foam between a body of the headrest and the soft goods/trim. The body of the headrest is typically made from the same or a similar material forming the backrest. The layer of foam may be different from the material forming the body and can include one or more of: expanded polystyrene (EPS), expanded polyurethane (EPU), expanded polyethylene (EPE), expanded polypropylene (EPP), porous expanded polypropylene (P-EPP), cross-linked expanded polyethylene (xEPE), or any other type of substantially incompressible foam material (i.e. having a compression strength of at least 6 psi @ 25% when measured according to ASTM-D3575 at the time of filing this application). The layer of foam is typically what provides the outer surface of the headrest in child restraints with a movable headrest while the seat shell itself typically provides the outer surface of the headrest in child restraints with an integral headrest.

The dimensions described above with respect to the embodiments shown in FIGS. 11-30 are applicable to child restraint 10. The dimensions described above with respect to the embodiments shown in FIGS. 11-30 are applicable to child restraint 210. The dimensions described above with respect to the embodiments shown in FIGS. 11-30 are applicable to child restraint 310. Reference is hereby made to U.S. application Ser. No. 19/213,506, filed May 20, 2025, which is hereby incorporated herein in its entirety for the purpose of describing various child restraints with a headrest and/or a side-impact management system to control forces acting on a child during a side impact event. The term about, as used herein, may indicate instances where slight manufacturing tolerances or measurements inaccuracies occur. Accordingly, it is understood that the various values described herein may not be exact.

1. A child restraint comprising
a seat bottom,
a backrest coupled to the seat bottom, the seat bottom and the backrest at least partially defining a child-receiving space configured to hold a child for transportation in a vehicle, and
a headrest coupled to the backrest, the headrest including a rear section, a first side section coupled to a first lateral side of the rear section, and a second side section coupled to a second lateral side of the rear section,
wherein each of the first side section and the second side section includes a first energy-absorption surface and a second energy-absorption surface, the first and second energy-absorption surfaces cooperating to provide each of the first side section and the second side section with a generally convex shape relative to the child-receiving space in an unloaded state prior to a force acting on the first side section or the second side section, and
wherein the first side section or the second side section are configured to change from the unloaded state to a loaded state in which the first and second energy-absorption surfaces of the first side section or the second side section cooperate to provide at least a portion of the first side section or the second side section with a concave shape relative to the child-receiving space in response to the force acting on the first side section or the second side section.

2. The child restraint of claim 1, wherein each side section further includes a transition point joining the first energy-absorption surface to the second energy-absorption surface, and wherein the first energy-absorption surface includes a first convex curvature and the second energy absorption surface includes a second convex curvature different than the first convex curvature.

3. The child restraint of claim 2, wherein the first and second side sections of the headrest further include a third energy-absorption surface having a concave curvature relative to the child-receiving space and a second transition point between the second energy-absorption surface and the third energy-absorption surface at a distal end of the second energy-absorption surface.

4. The child restraint of claim 2, wherein the first energy-absorption surface extends at a first absolute slope relative to the rear section and the second energy-absorption surface extends at a second absolute slope relative to the rear section, the second absolute slope is less than the first absolute slope.

5. The child restraint of claim 1, wherein the backrest and the headrest are formed integrally with one another from one or more polymeric materials and the headrest has a substantially constant thickness between an outer surface of the first and second side sections including the first and second energy-absorption surfaces and an inner surface facing away from the outer surface in both the unloaded state and the loaded state.

6. The child restraint of claim 1, wherein the backrest includes a rear wall, a first side wing coupled to a first lateral side of the rear wall and extending in a forward direction away from the rear wall, and a second side wing coupled to a second lateral side of the rear wall and extending in the forward direction away from the rear wall, and wherein the first side wing and the second side wing each include a side wing panel coupled to the rear wall and spaced a first distance from a lateral centerline of the child restraint and a hip region support coupled to the side wing panel and extending inwardly toward the lateral centerline of the child restraint to space at least a portion of the hip region support a second distance from the lateral centerline, the second distance being less than the first distance.

7. The child restraint of claim 6, wherein the hip region support has an outer surface facing toward the child-receiving space and having a convex shape relative to the child-receiving space in an unloaded state, and the hip region support is configured to deform in response to a load acting on the hip region support to a loaded state in which the outer surface of the hip region support has a concave shape relative to the child-receiving space.

8. The child restraint of claim 7, wherein the backrest is formed from one or more polymeric materials and the hip region support has a substantially constant thickness between the outer surface of the hip region support and an inner surface facing away from the outer surface in both the unloaded state and the loaded state.

9. The child restraint of claim 1, wherein the backrest includes a rear wall, a first side wing coupled to a first lateral side of the rear wall and extending in a forward direction away from the rear wall, and a second side wing coupled to a second lateral side of the rear wall and extending in the forward direction away from the rear wall, and wherein the first side wing and the second side wing are each formed to include a shoulder-receiving recess.

10. The child restraint of claim 9, wherein the first side wing and the second side wing each include a rear segment coupled to the rear wall and extending in a forward direction away from the rear wall, a laterally-extending segment coupled to a forward end of the rear segment and extending laterally away from the rear wall, and an outwardly-extending segment coupled to an outer end of the laterally-extending segment and extending in the forward direction away from the laterally-extending segment, the rear segment, and the rear wall, and wherein the laterally-extending segment and the outwardly-extending segment at least partially define the shoulder-receiving recess.

11. The child restraint of claim 1, wherein the headrest further includes a first reinforcement rib coupled to a backside of the first side section and a second reinforcement rib coupled to a backside of the second side section, the first reinforcement rib having a proximal end located laterally between the transition point and a distal end of the first energy-absorption surface of the first side section, and the second reinforcement rib having a proximal end located laterally between the transition point and a distal end of the first energy-absorption surface of the second side section.

12. The child restraint of claim 11, wherein the transition point is spaced a first distance from the reinforcement rib in the unloaded state and a second distance, less than the first distance, in the loaded state.

13. A child restraint comprising:
a seat bottom,
a backrest coupled to the seat bottom, the seat bottom and the backrest at least partially defining a child-receiving space configured to hold a child for transportation in a vehicle, and
a headrest coupled to the backrest, the headrest including a rear section, a first side section coupled to a first lateral side of the rear section, and a second side section coupled to a second lateral side of the rear section, wherein each of the first side section and the second side section includes a first energy-absorption surface, a second energy-absorption surface and a transition point between the first and second energy-absorption surfaces such that the first energy-absorption surface has a first absolute slope relative to the rear section and the second energy-absorption surface has a second absolute slope relative to the rear section different than the first absolute slope,
wherein the backrest includes a rear wall, a first side wing coupled to a first lateral side of the rear wall and extending in a forward direction away from the rear wall, and a second side wing coupled to a second lateral side of the rear wall and extending in the forward direction away from the rear wall, and
wherein the first side wing and the second side wing are each formed to include a shoulder-receiving recess configured to receive a shoulder region of the child during the side impact event.

14. The child restraint of claim 13, wherein the first side wing and the second side wing each include a rear segment coupled to the rear wall and extending in a forward direction away from the rear wall, a laterally-extending segment coupled to a forward end of the rear segment and extending laterally away from the rear wall, and an outwardly-extending segment coupled to an outer end of the laterally-extending segment and extending in the forward direction away from the laterally-extending segment, the rear segment, and the rear wall, and wherein the laterally-extending segment and the outwardly-extending segment at least partially define the shoulder-receiving recess.

15. The child restraint of claim 13, wherein the first energy-absorption surface includes a first convex curvature and the second energy absorption surface includes a second convex curvature different than the first convex curvature.

16. The child restraint of claim 15, wherein the first and second side sections of the headrest further include a third energy-absorption surface having a concave curvature relative to the child-receiving space and a second transition point between the second energy-absorption surface and the third energy-absorption surface at a distal end of the second energy-absorption surface.

17. The child restraint of claim 13, wherein the backrest and the headrest are formed integrally with one another from one or more polymeric materials and the headrest has a substantially constant thickness between an outer surface of the first and second side sections including the first and second energy-absorption surfaces and an inner surface facing away from the outer surface.

18. The child restraint of claim 17, wherein at least one of the first and second side sections is configured to deform from an unloaded state, in which the first and second side sections provide a generally convex shape relative to the child-receiving space, to a loaded state, in which the at least one of the first and second side sections provide a concave shape relative to the child-receiving space, in response to a force acting on the at least one of the first and second side sections from the child's head during a side impact.

19. A child restraint comprising:
a seat bottom,
a backrest coupled to the seat bottom, the seat bottom and the backrest at least partially defining a child-receiving space configured to hold a child for transportation in a vehicle, and
a headrest coupled to the backrest, the headrest including a rear section, a first side section coupled to a first lateral side of the rear section, and a second side section coupled to a second lateral side of the rear section, wherein each of the first side section and the second side section includes a first energy-absorption surface, a second energy-absorption surface and a transition point between the first and second energy-absorption surfaces such that the first energy-absorption surface has a first absolute slope relative to the rear section and the second energy-absorption surface has a second absolute slope relative to the rear section different than the first absolute slope,
wherein the transition point is: (i) spaced a width distance from a centerline of the headrest between the first and second side sections within a range of 50 mm to 110 mm, (ii) spaced a depth distance from a seating surface provided by the headrest within a range of 25 mm to 100 mm, and (iii) space a distance of not more than 60 mm from a reference point established by a center of gravity of a head of a 3 year old test dummy sized according to Subpart W from 49 CFR part 572 when the dummy is coupled to the child restraint for side impact testing.

20. The child restraint of claim 19, wherein the backrest includes a rear wall, a first side wing coupled to a first lateral side of the rear wall and extending in a forward direction away from the rear wall, and a second side wing coupled to a second lateral side of the rear wall and extending in the forward direction away from the rear wall, and wherein the first side wing and the second side wing are each formed to include a shoulder-receiving recess, and
wherein the first side wing and the second side wing each include a rear segment coupled to the rear wall and extending in a forward direction away from the rear wall, a laterally-extending segment coupled to a forward end of the rear segment and extending laterally away from the rear wall, and an outwardly-extending segment coupled to an outer end of the laterally-extending segment and extending in the forward direction away from the laterally-extending segment, the rear segment, and the rear wall, and wherein the laterally-extending segment and the outwardly-extending segment at least partially define the shoulder-receiving recess.
